(19) United States
(12) Patent Application Publication
(10) Pub. No.: US 2015/0089371 A1
(43) Pub. Date: Mar. 26, 2015

(54) SYSTEMS AND METHODS FOR PRESENTING VIDEO/AUDIO CONTENT AND METADATA FOR A BROADBAND TELEVISION SERVICE

(71) Applicant: WebTuner, Corp., Redmond, WA (US)

(72) Inventors: Eduard Zaslavsky, Issaquah, WA (US); Thomas E. Nichols, Redmond, WA (US)

(21) Appl. No.: 14/496,199

(22) Filed: Sep. 25, 2014

Related U.S. Application Data
(60) Provisional application No. 61/882,346, filed on Sep. 25, 2013.

(51) Int. Cl. G06F 3/0482; G06F 3/0484; G06F 3/0481

(52) U.S. Cl. CPC G06F 3/0482; G06F 3/04817; G06F 3/0484
USPC 715/716

(57) ABSTRACT

Embodiments described herein are directed to systems and methods for processing, compression, transmission, storage, decompression, rendering and user interaction with video/audio content and content metadata. This systems and methods simplify the way a user will find relevant content and interact with it. That system and method include, for example a Personalized User Interface, a Personalized Recommendation Processor/Engine, a Unified Search Service and User Interface (through Linear TV, Movies, TV Shows, Celebrities), an Audience Measurement Platform, an Addressable Interactive Advertisement Platform and User Interface, and a TV Adapter and Remote.

### REFERENCE TO RELATED APPLICATIONS

This application claims priority to U.S. provisional Application Ser. No. 61/882346, filed Sep. 25, 2013, entitled “Systems and Methods for Presenting Video/Audio Content and Metadata for a Broadband Television Service,” which is hereby specifically and entirely incorporated by reference.

### BACKGROUND

1. Field of the Invention

The invention is directed to media consumption. Particularly, the invention is directed toward broadband television consumption.

2. Background of the Invention

Today, Broadband TV Service provides access to the multiple sources of content, including hundreds of Live TV (Linear) channels and tens of thousands movies and TV shows. It's very difficult for average user to find relevant a TV show or movie in such huge amount of content.

### SUMMARY OF THE INVENTION

The present invention overcomes the problems and disadvantages associated with current strategies and designs and provides new tools and methods of finding media content to view.

One embodiment of the invention is directed to a system for displaying a user interface (UI) on a display device. The system comprises a computing device coupled to the display device, a controller adapted to provide instructions to the computing device and software executing on the computing device. The software is adapted to, as an overlay on a full screen video, display a main menu, the main menu comprising a first plurality of icons in a strip, one icon displaying a reference to a current user and at least one other icon displaying a reference to a category, receive a selection of one of the first plurality of icons, display a first submenu associated with the selected icon, the first submenu comprising a second plurality of icons in a strip, receive a selection of one of the second plurality of icons, and at least one of display a second submenu and change the full screen video based on the selection of one of the second plurality of icons. The first submenu replaces the main menu upon the selection of the icon.

Preferably, there are a plurality of other icons in the main menu, each displaying a reference to a different category. In a preferred embodiment, the category is at least one of live TV, movie library, show library, sports, celebrities, favorites, and extras. Preferably, each icon of the main menu is associated with a different first submenu. Preferably, there are additional submenus associated with each selection, each submenu comprising a plurality of icons in a strip and each icon displaying a different option for that submenu. At least one additional submenu preferably provides information about a selected icon. The information is preferably related to at least one of a selected show, a selected movie, and a selected celebrity. Preferably, each icon displays at least one of an image, video, or text.

Preferably, the software is further adapted to control playback of the full screen video. In a preferred embodiment, the software is further adapted to display information related to the full screen video during control of playback. Preferably, software is adapted to receive and store a selection of a favorite, a selection of a video to add to a watchlist, an indication that the user likes the currently displaying full screen video or selected icon, or a an indication that the user dislikes the currently displaying full screen video or selected icon. The full screen video is preferably one of a live TV show, a streaming TV show, a live movie, a streaming movie, information from the Internet, and an IPTV video. The software preferably displays options of viewing content from multiple sources simultaneously. Preferably, the software displays options of viewing content from multiple sources without indicating the source.

Preferably, the multiple sources are chosen from the list comprising live TV, streaming videos, the Internet, IPTV, cable systems, satellite systems, and DVR. Preferably, the software is further adapted to display an icon indicating that the full screen video contains an interactive feature. In a preferred embodiment, the software is further adapted to display the interactive feature and accept interaction from the user upon the user selecting to view the interactive feature. Preferably, the user is able to navigate through different submenus without returning to the main menu. Preferably, the user is able to search for content and information using key words. There are preferably a plurality of users and each user is able to customize the user interface.

Another embodiment of the invention is directed to a method for displaying a user interface (UI) as an overlay on a full screen video on a display device. The method comprising the steps of, on a computing device coupled to the display device, displaying a main menu, the main menu comprising a first plurality of icons in a strip, one icon displaying a reference to a current user and at least one other icon displaying a reference to a category, receiving a selection of one of the first plurality of icons, displaying a first submenu associated with the selected icon, the first submenu comprising a second plurality of icons in a strip, receiving a selection of one of the second plurality of icons, and at least one of displaying a second submenu and changing the full screen video based on the selection of one of the second plurality of icons. The first submenu replaces the main menu upon the selection of the icon;

In a preferred embodiment, there are a plurality of other icons in the main menu, each displaying a reference to a different category. Preferably, the category is at least one of live TV, movie library, show library, sports, celebrities, favorites, and extras. Each icon of the main menu is preferably associated with a different first submenu. Preferably, there are additional submenus associated with each selection, each submenu comprising a plurality of icons in a strip and each icon displaying a different option for that submenu. In a preferred embodiment, at least one additional submenu provides information about a selected icon. The information is preferably related to at least one of a selected show, a selected movie, and a selected celebrity. Preferably, each icon displays at least one of an image, video, or text.

The method preferably further comprises controlling playback of the full screen video. The method preferably further comprises displaying information related to the full screen video during control of playback. The method preferably further comprises receiving and storing a selection of a favorite, a selection of a video to add to a watchlist, an indication that the user likes the currently displaying full screen video or selected icon, or a an indication that the user dislikes the currently displaying full screen video or selected icon. Preferably, the full screen video is one of a live TV show, a streaming TV show, a live movie, a streaming movie, information from the Internet, and an IPTV video.

The method preferably further comprises displaying options of viewing content from multiple sources simultaneously. The method preferably further comprises options of viewing content from multiple sources without indicating the source. Preferably, the multiple sources are chosen from the list comprising live TV, streaming videos, the Internet, IPTV, cable systems, satellite systems, and DVR. The method preferably further comprises displaying an icon indicating that the full screen video contains an interactive feature. The method preferably further comprises displaying the interactive feature and accepting interaction from the user upon the user selecting to view the interactive feature. Preferably, the user is able to navigate through different submenus without returning to the main menu. The user is preferably able to search for content and information using key words. In a preferred embodiment, there are a plurality of users and each user is able to customize the user interface.

Other embodiments and advantages of the invention are set forth in part in the description, which follows, and in part, may be obvious from this description, or may be learned from the practice of the invention.

### DESCRIPTION OF THE DRAWING

The invention is described in greater detail by way of example only and with reference to the attached drawing, in which:

FIG. 1 Shows an embodiment of a User Interface for a Main Menu.

FIG. 2a Describes an embodiment of User Interface Elements and Navigation flow for the Main Menu.

FIG. 2-5 Show an embodiment of a User Interface and navigation from the Main Menu to a Live TV menu to a Channel Menu to a TV Program List.

FIG. 3a Describes an embodiment of User Interface Elements and Navigation flow for the Main Menu, Live TV menu, Channel Menu, TV Program List.

FIGS. 6-9 Show an embodiment of User Interface and navigation from a TV Program List to a TV Program Extended View to a cast and crew list to the actor extended view screen.

FIG. 4a Describes an embodiment of User Interface Elements and Navigation flow for the TV Program List, TV Program Extended View, Cast & Crew List, and Actor Extended View Screen.

FIGS. 10-13 Show an embodiment of a User Interface and navigation from an Actor Extended View Screen to an Actor Show List to an Actor Show List Extended View to a Show Cast & Crew Compact List.

FIG. 5a Describes an embodiment of User Interface Elements and Navigation flow for the Actor Extended View Screen, Actor Show List, Actor Show List Extended View, Show Cast & Crew Compact List.

FIGS. 14-17 Show an embodiment of main, movie, genre, and move library screens.

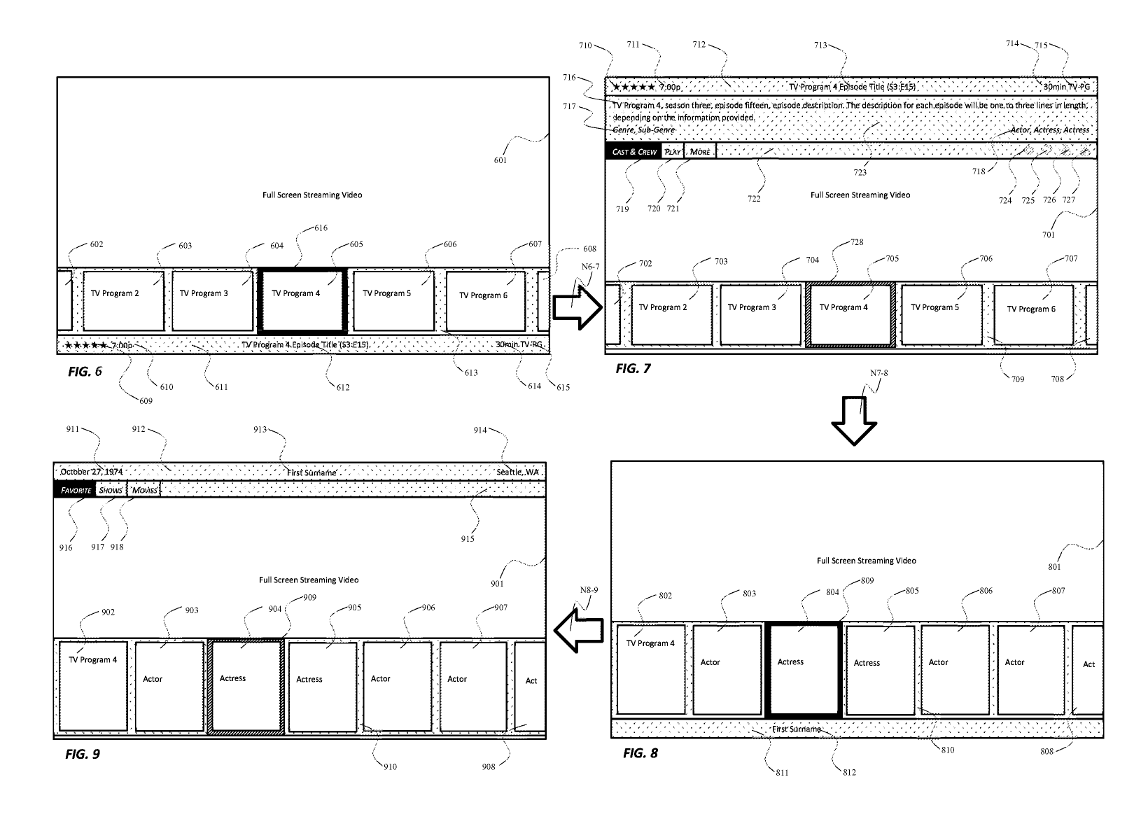

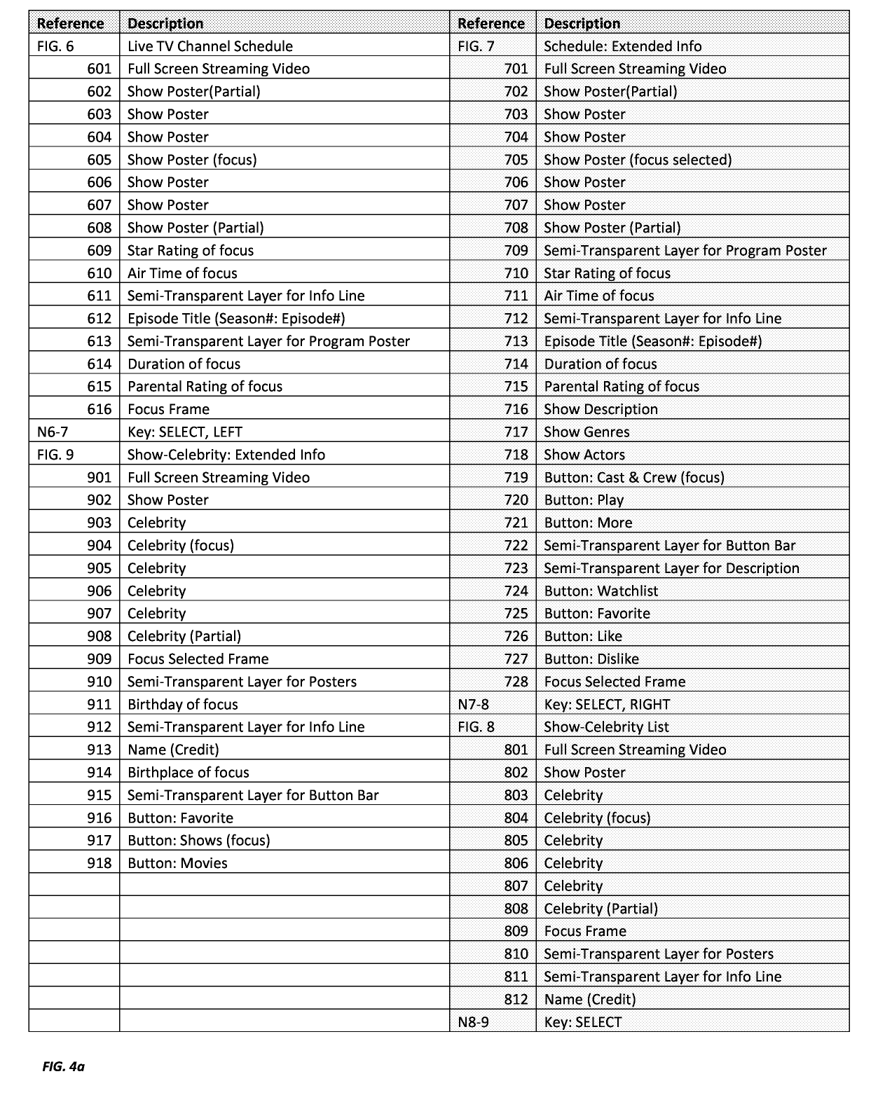

FIG. 6a Describes an embodiment of User Interface Elements and Navigation flow for the main, movie, genre, move library screens.

FIGS. 18-21 Show an embodiment of movie library, movie library extended information, movie-celeb, and movie-celeb extended information screens.

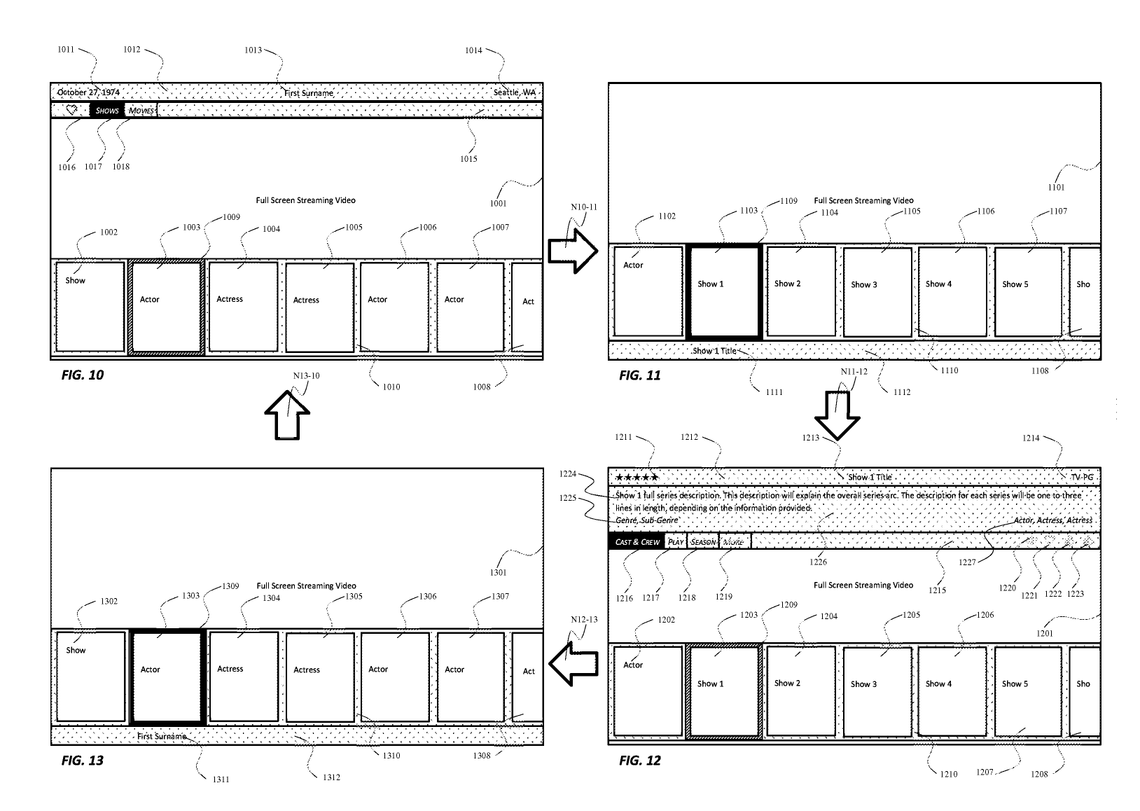

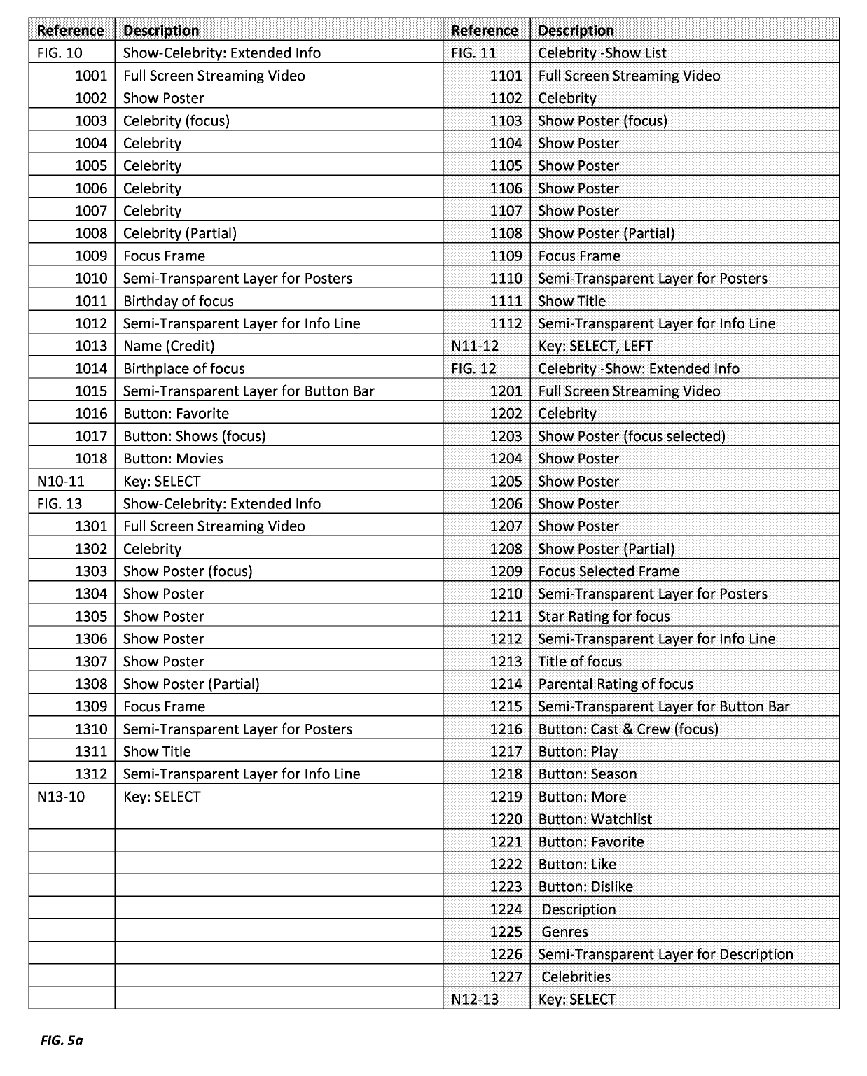

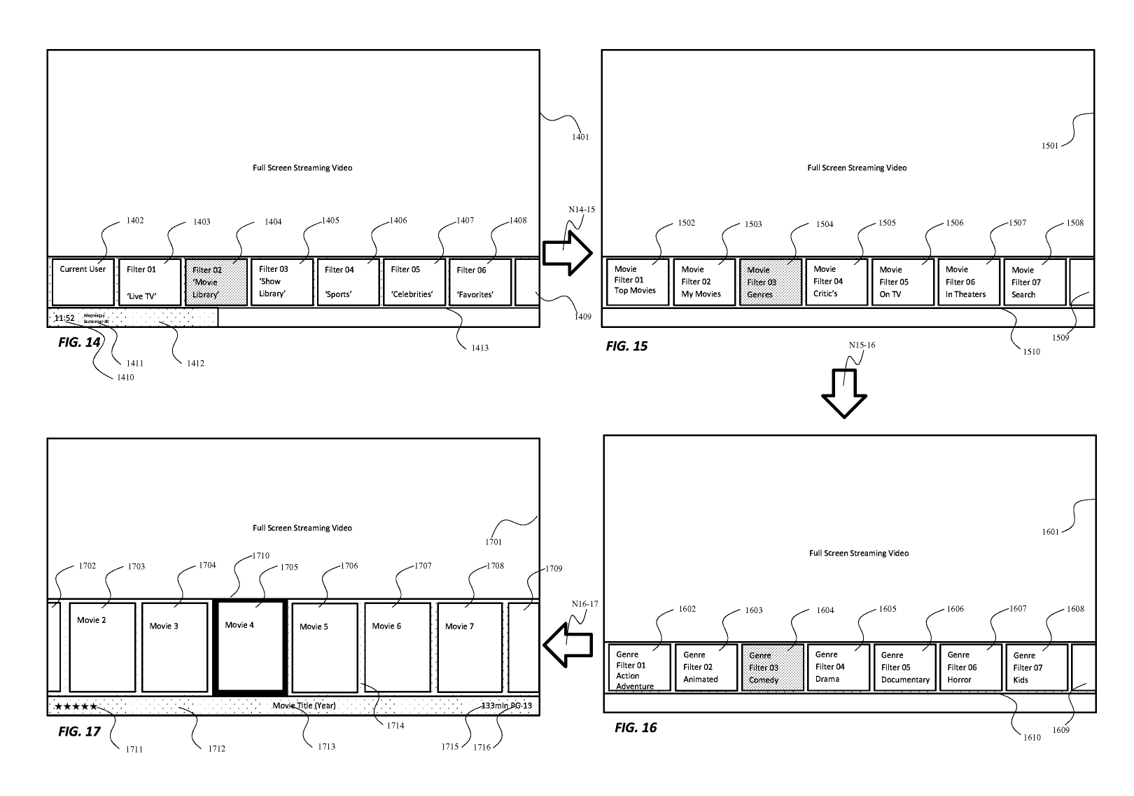

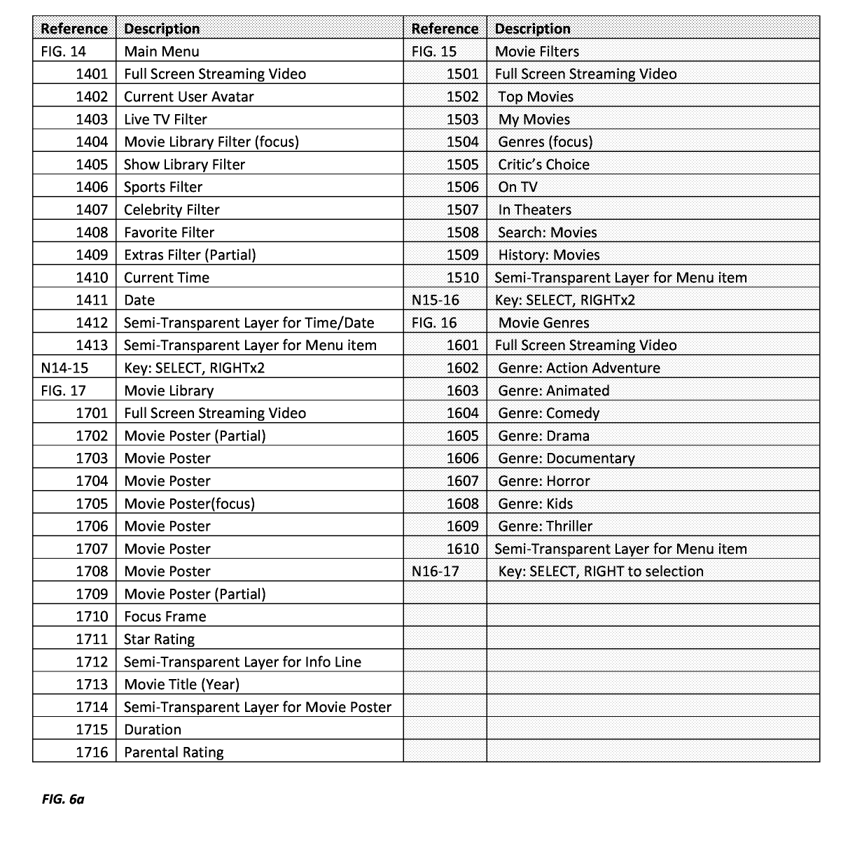

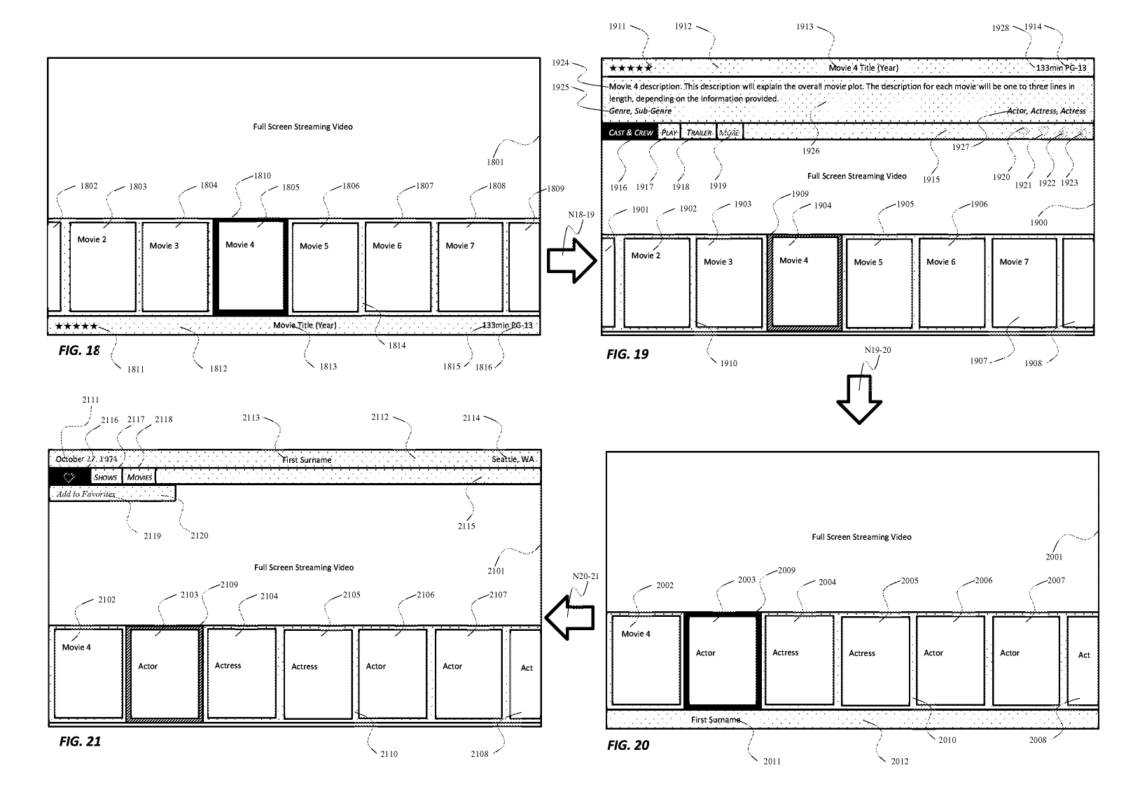

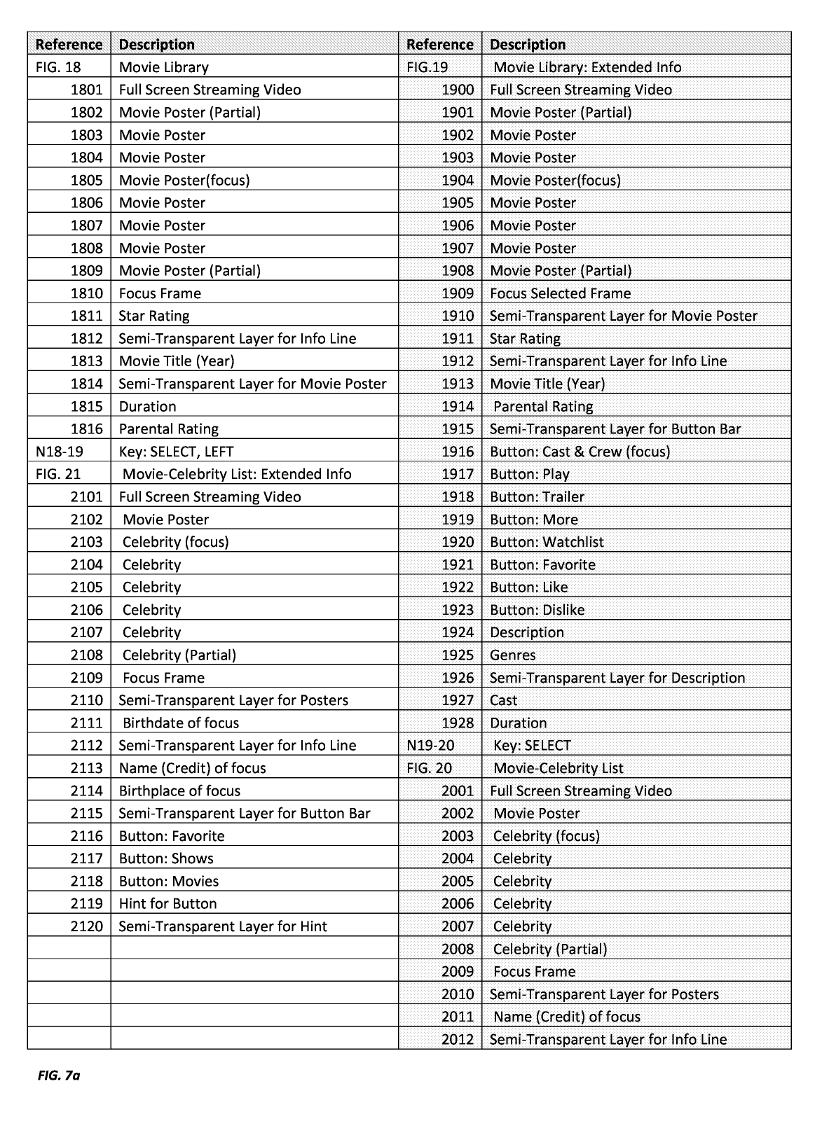

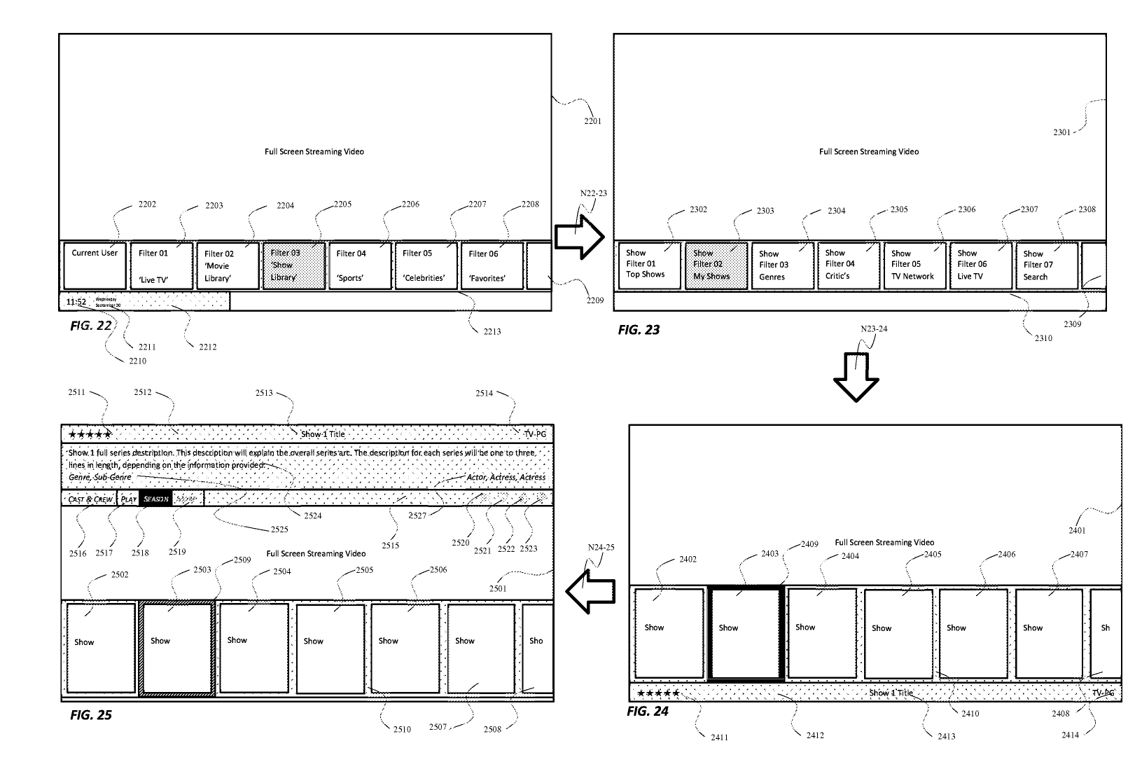

FIG. 7a Describes an embodiment of User Interface Elements and Navigation flow for the movie library, movie library extended information, movie-celeb, and movie-celeb extended information screens.

FIGS. 22-25 Show an embodiment of main, show, my show library, and show library extended information screens.

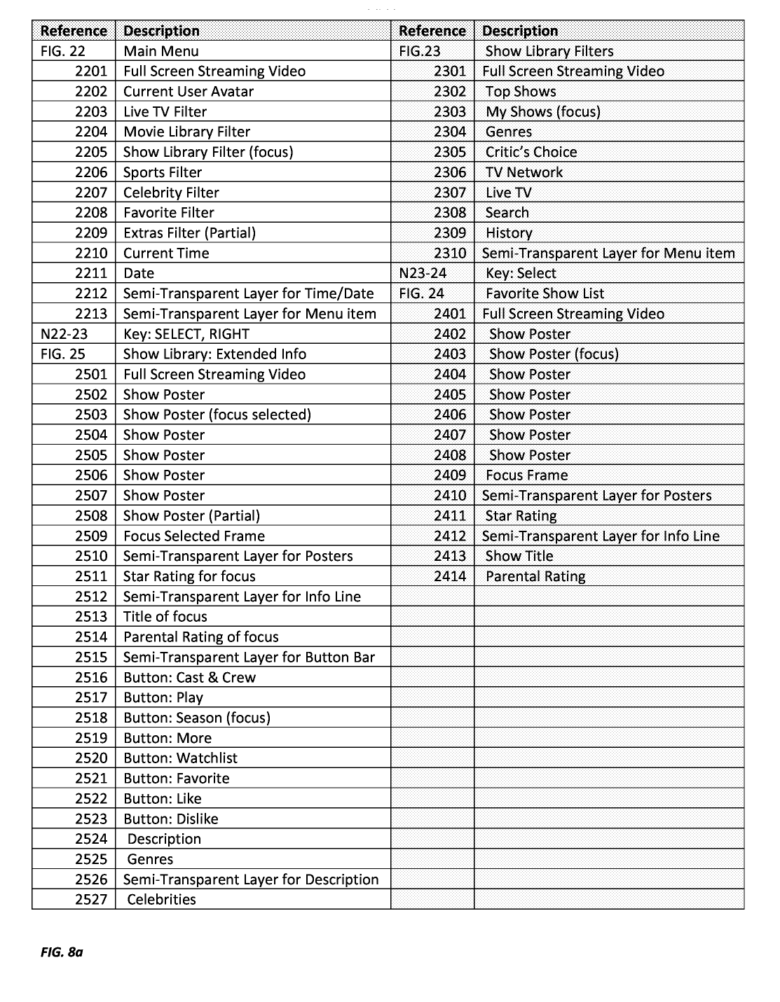

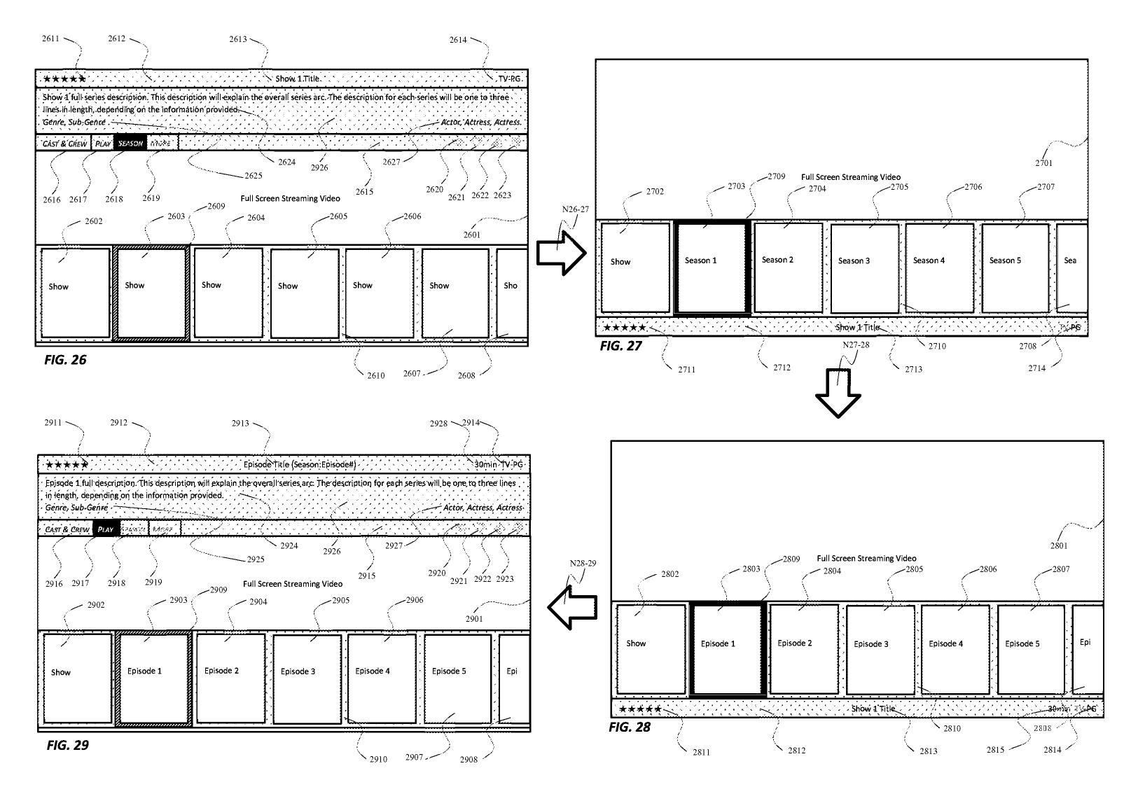

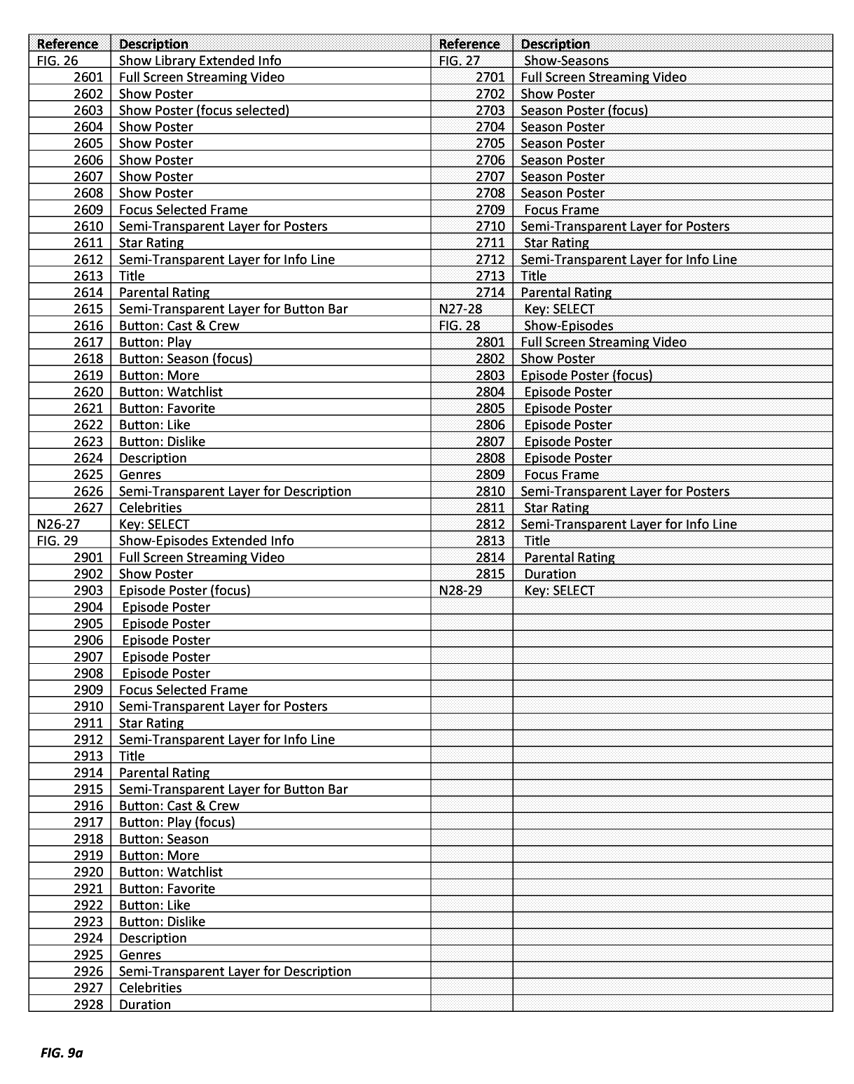

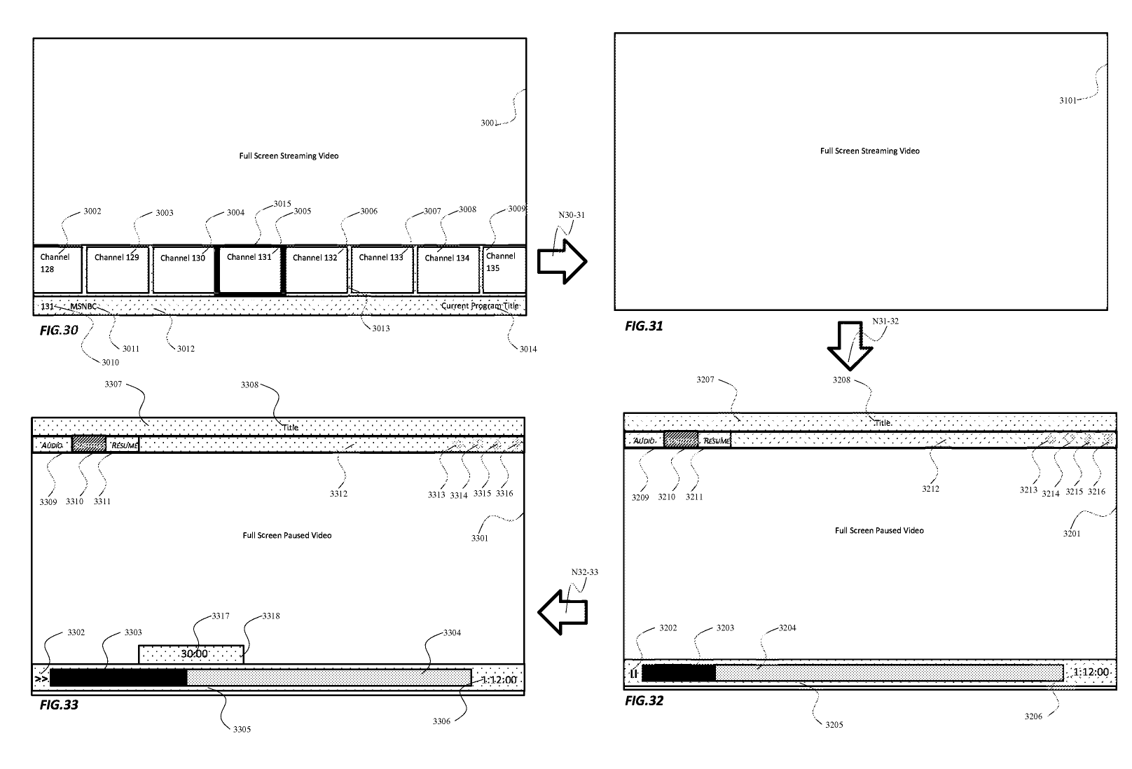

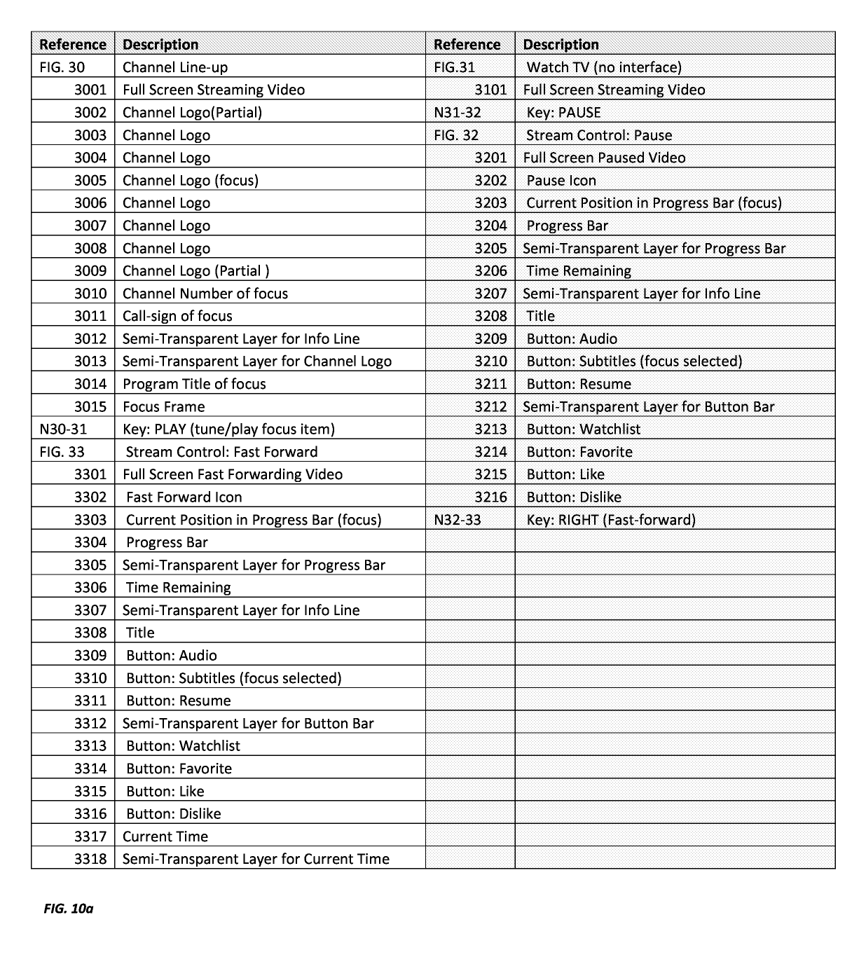

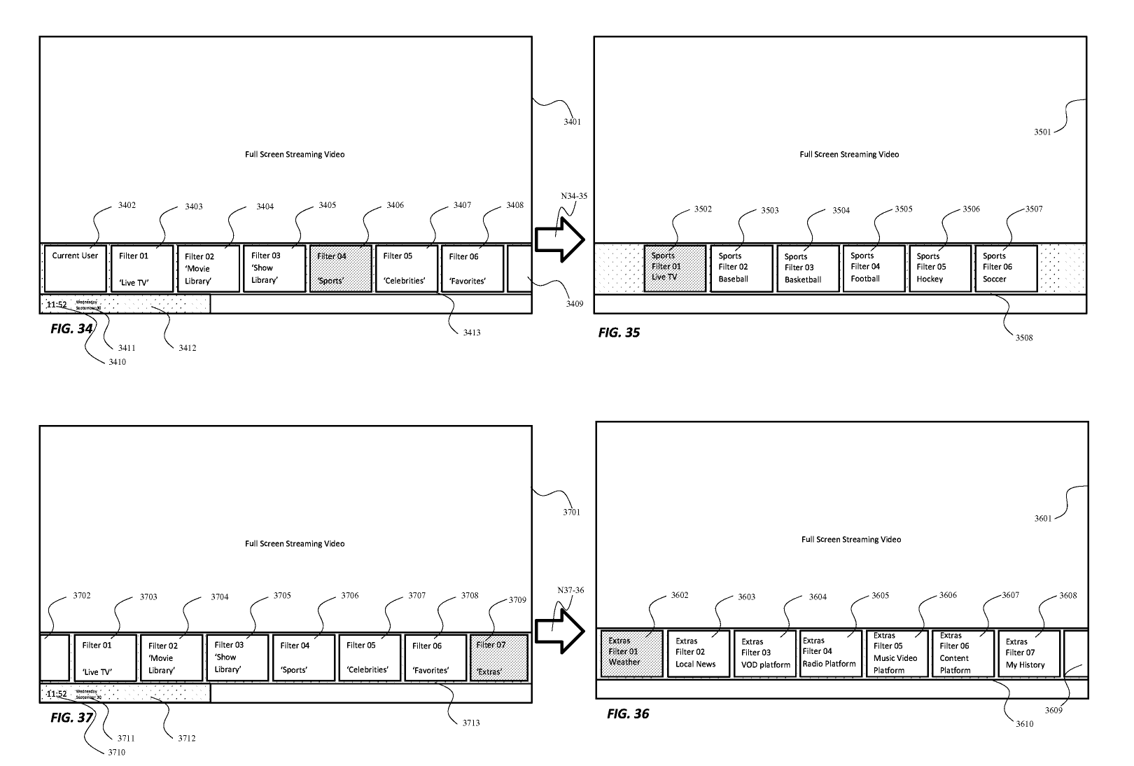

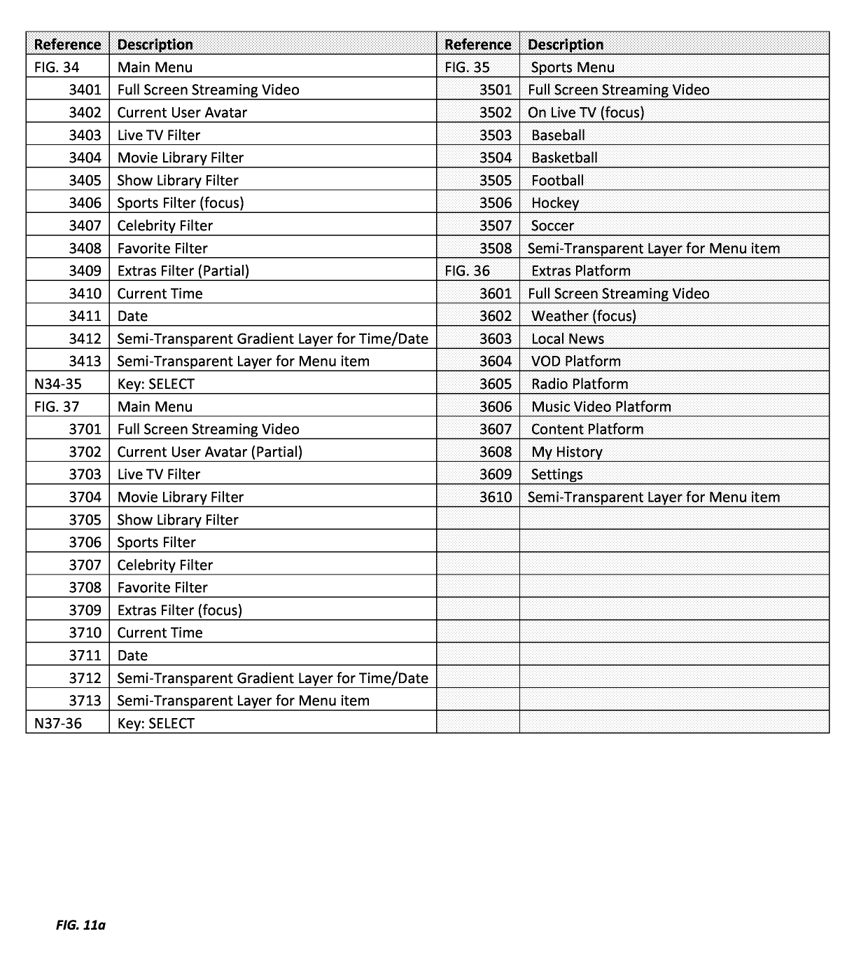

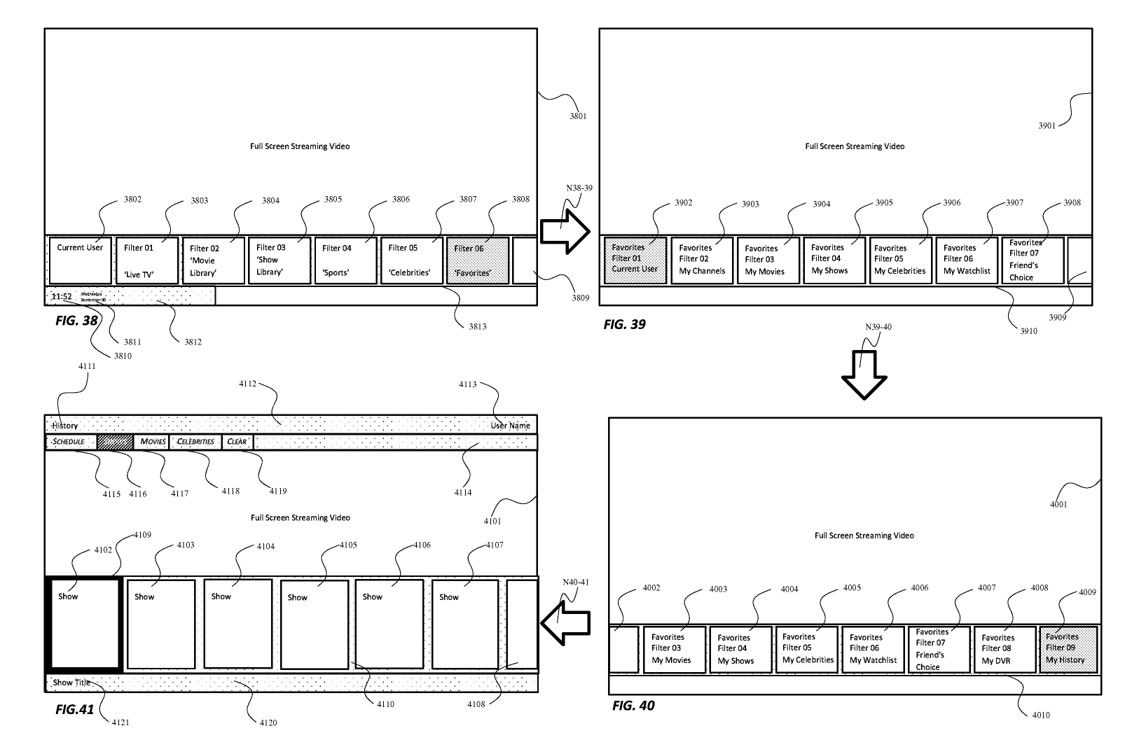

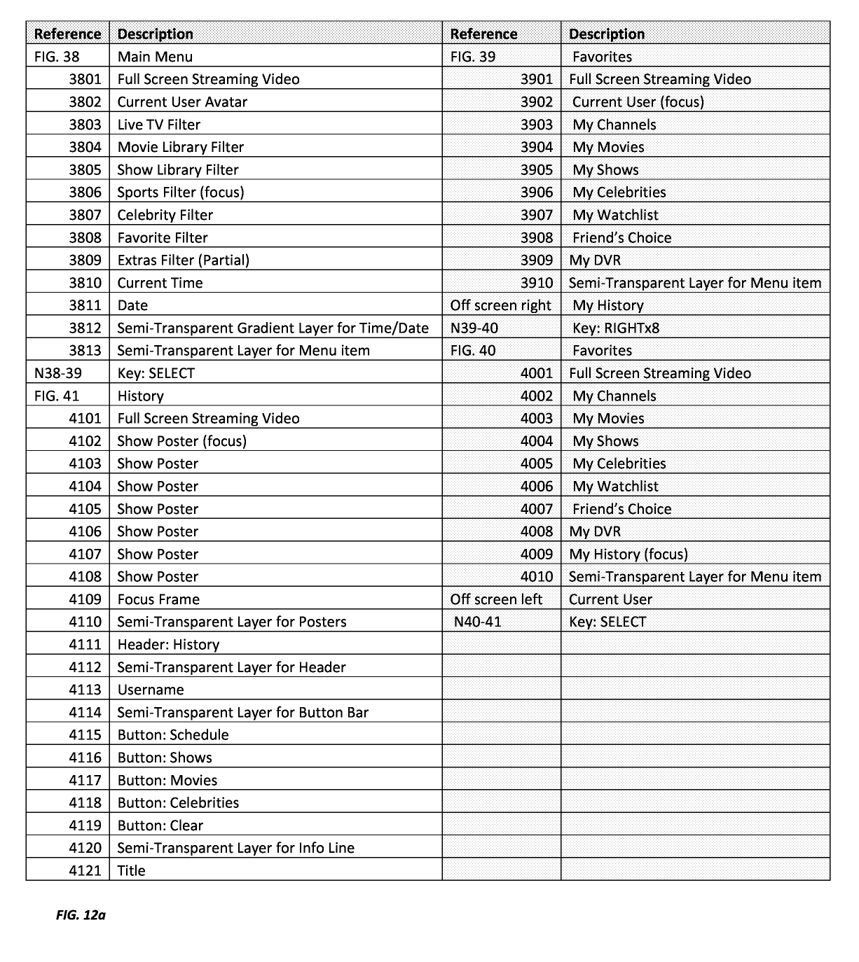

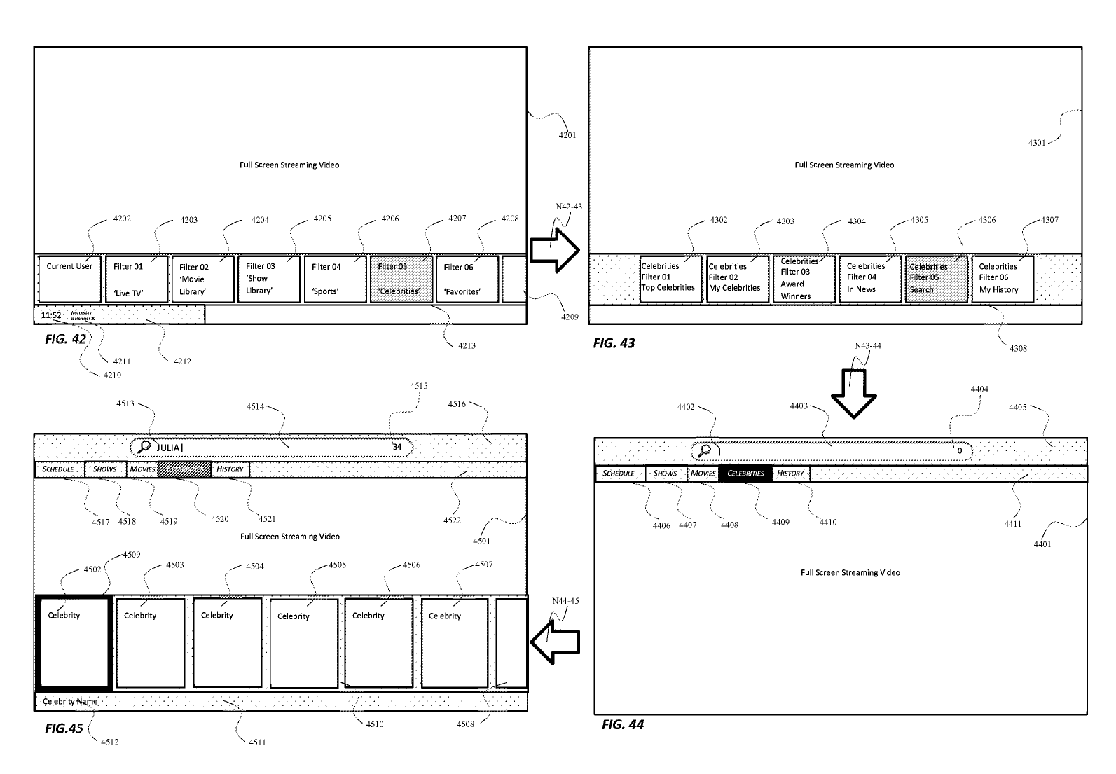

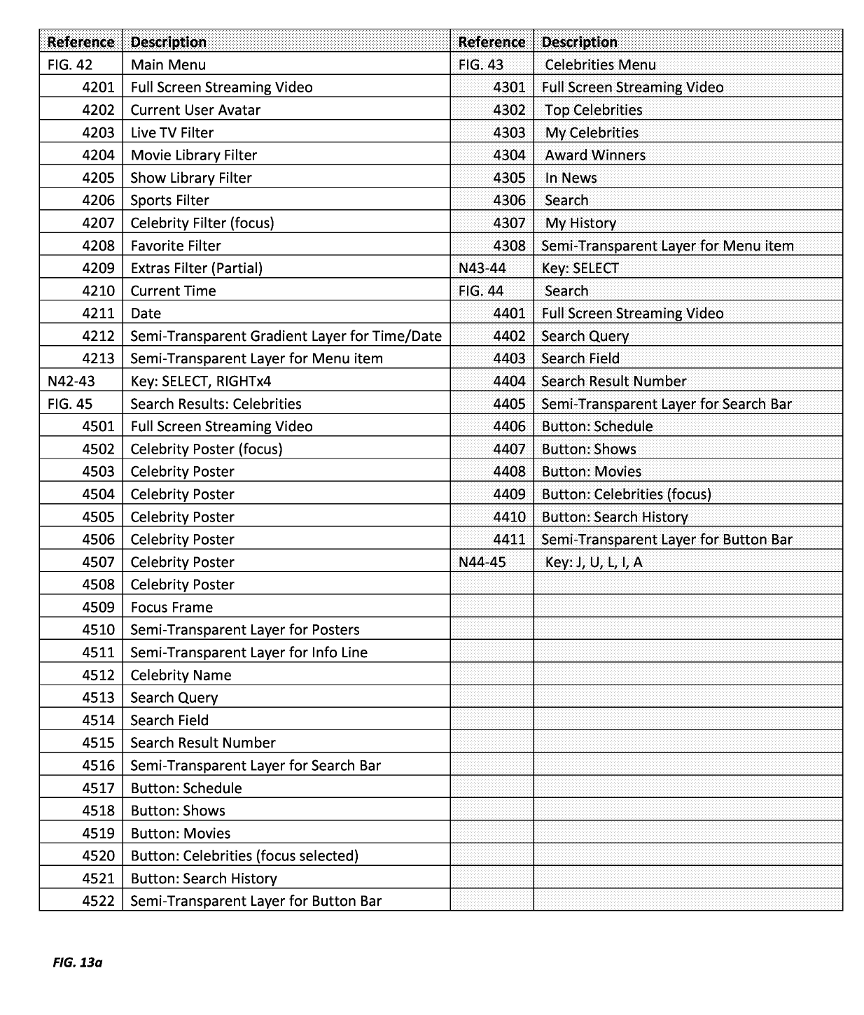

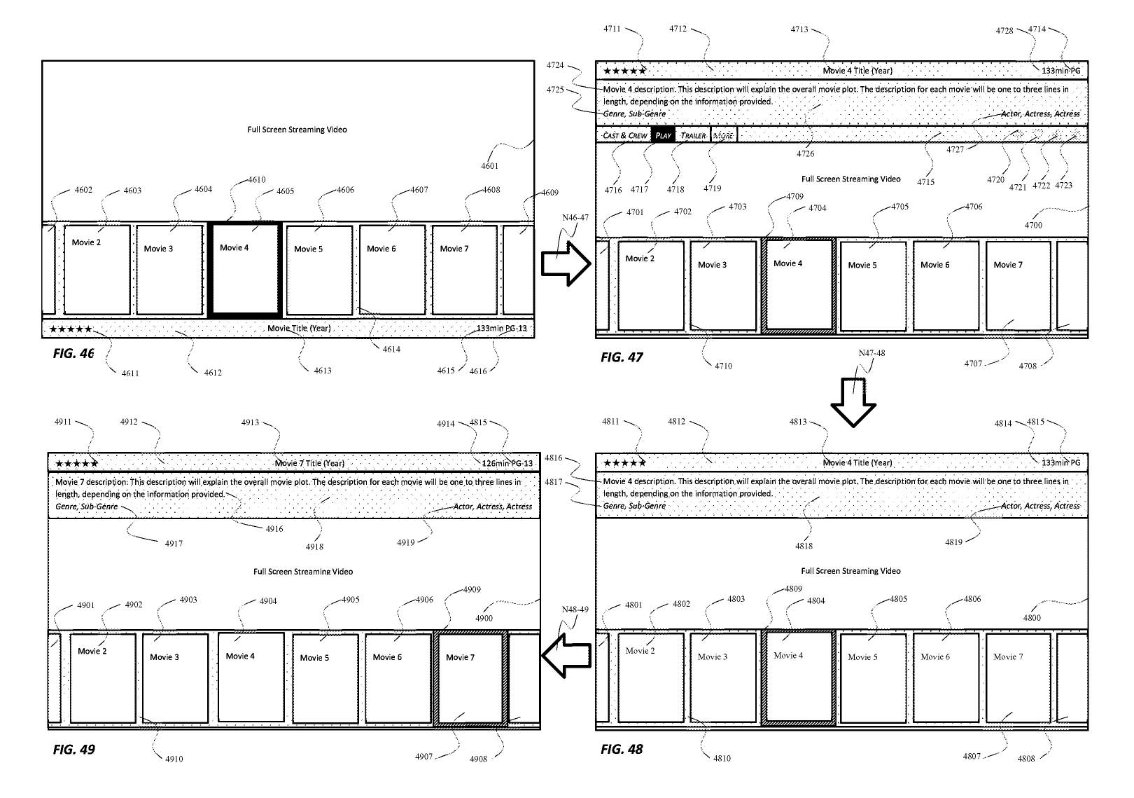

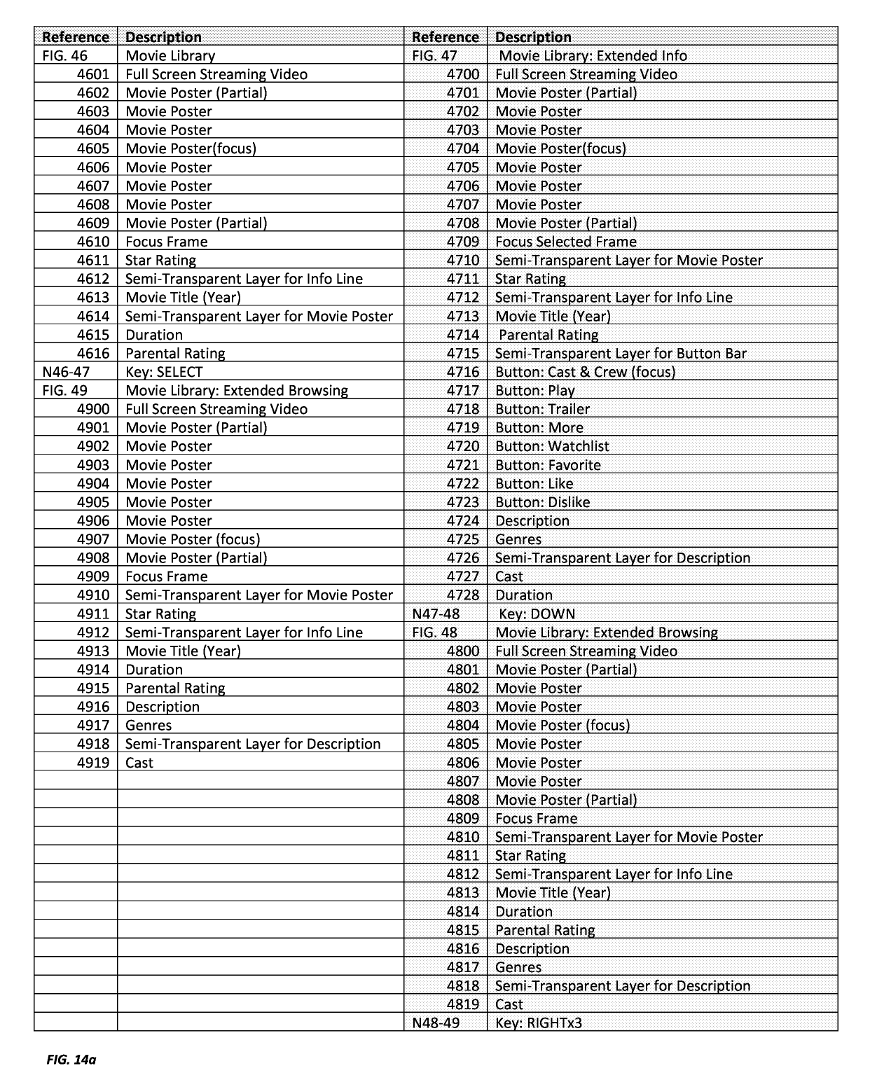

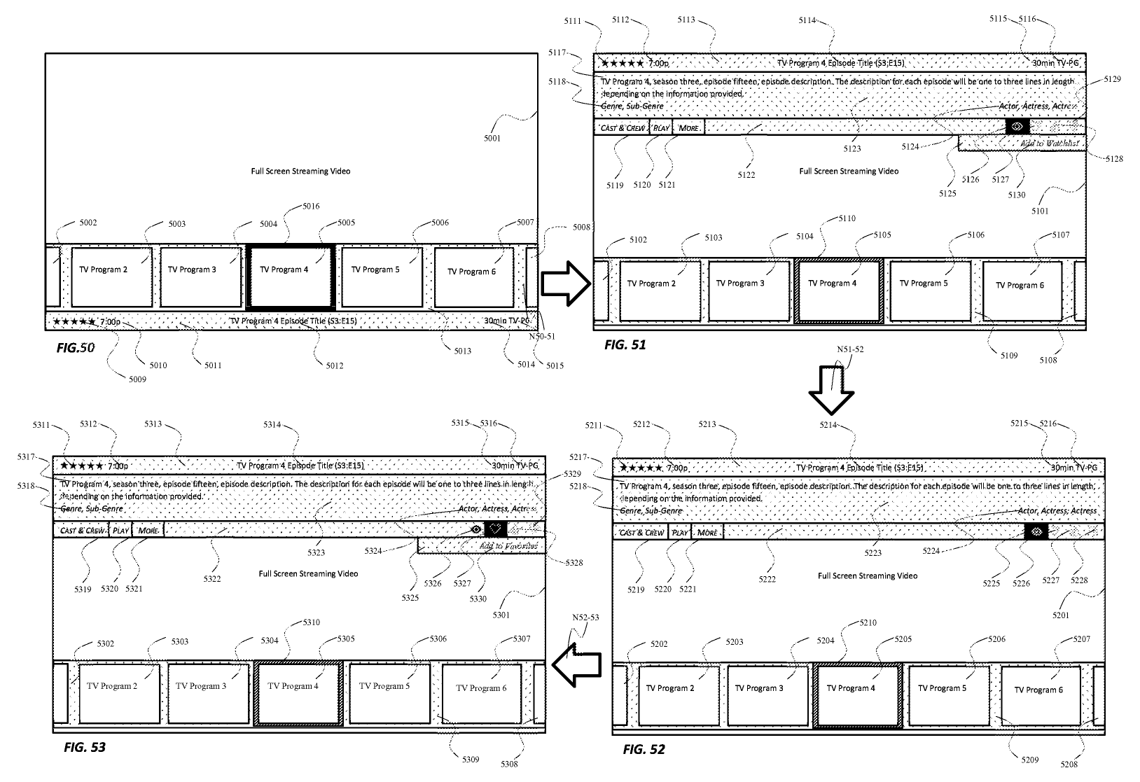

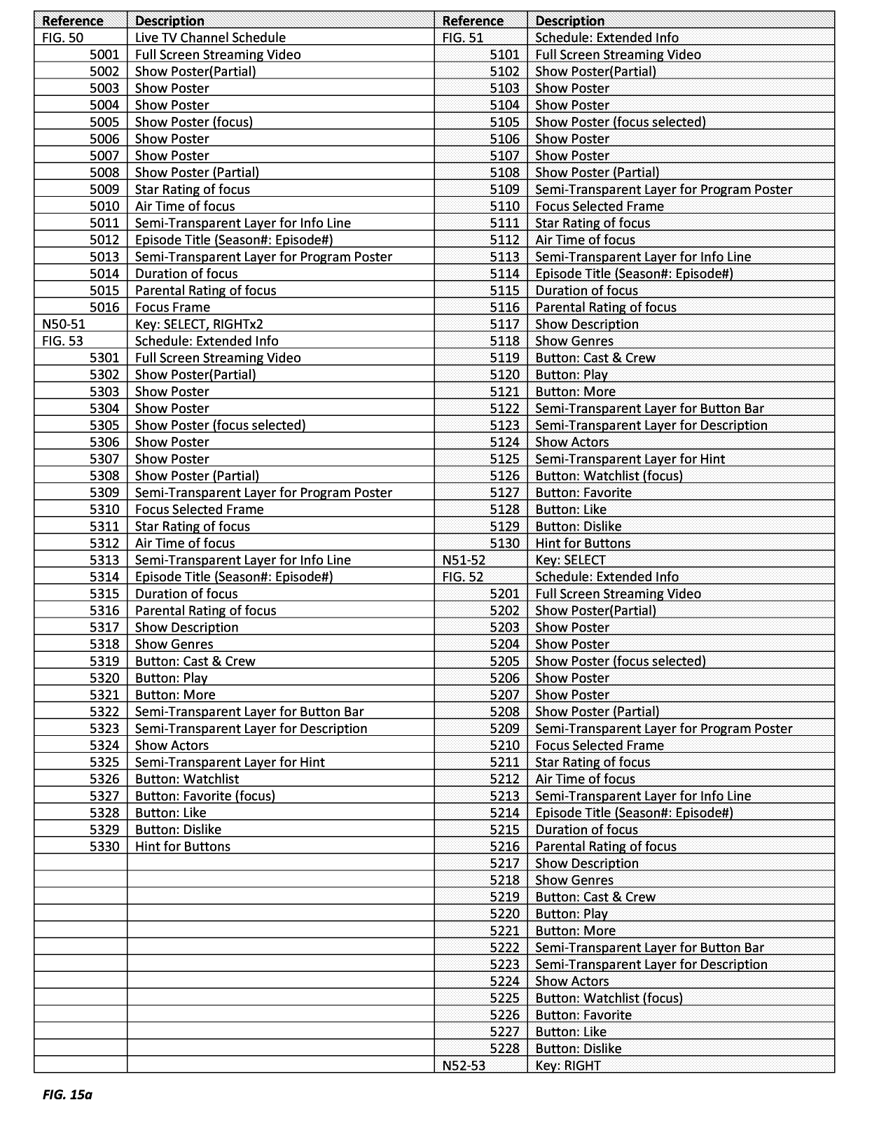

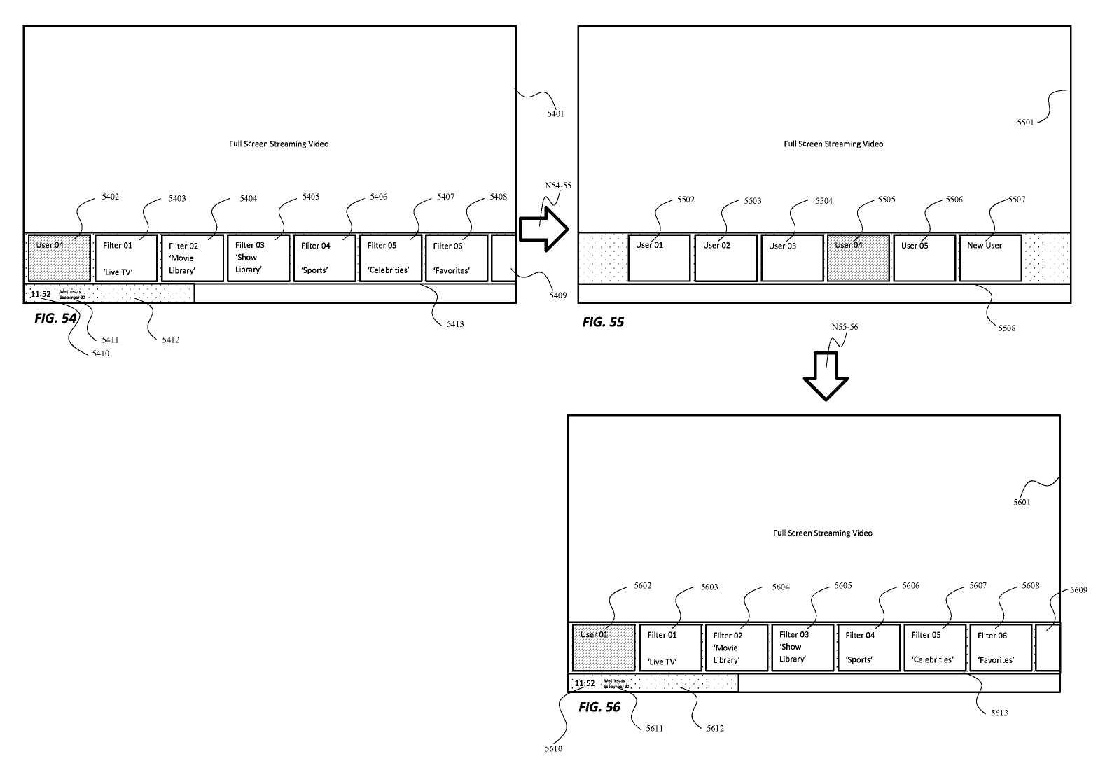

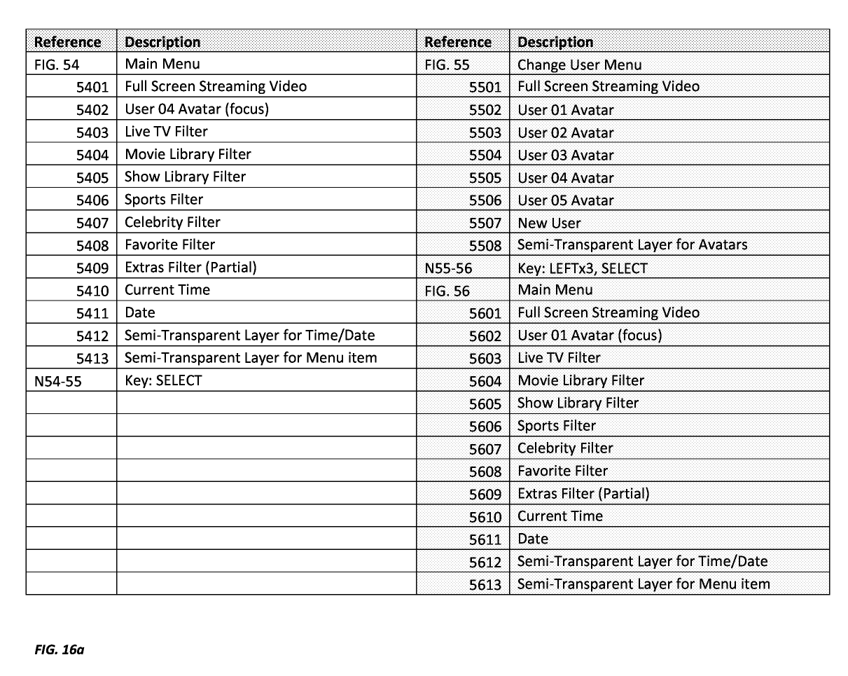

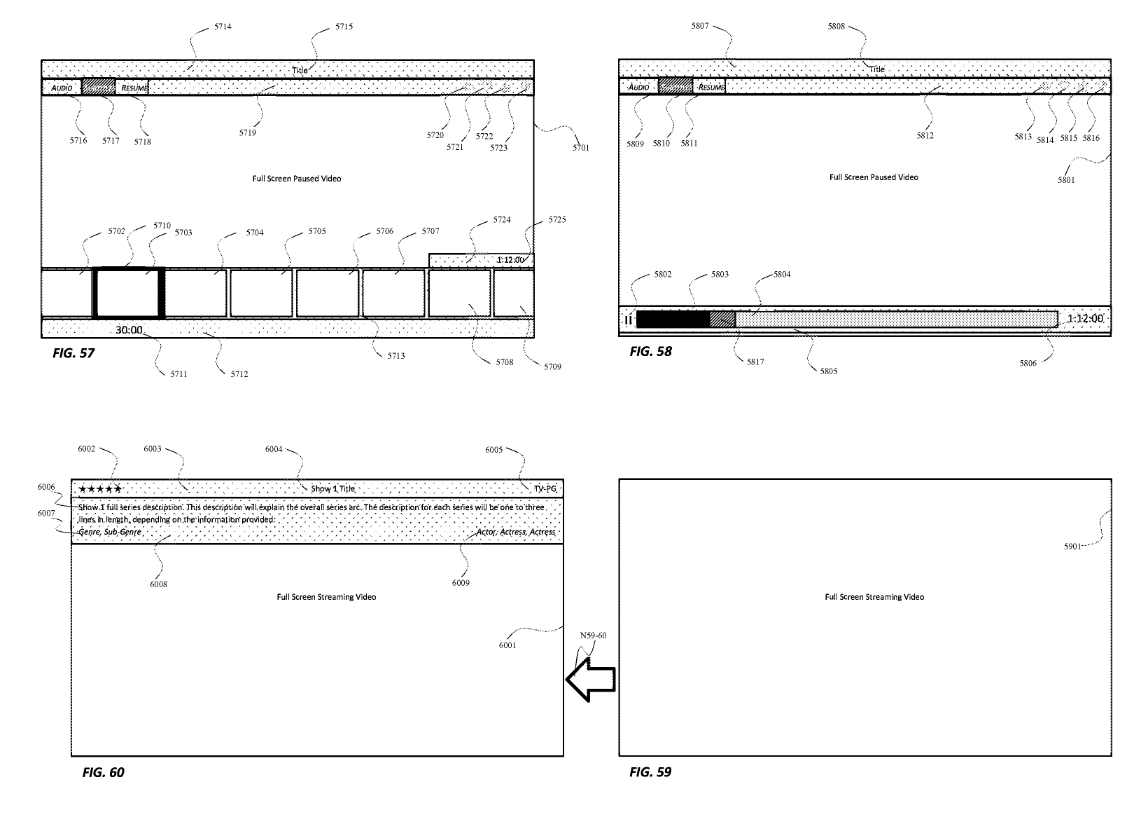

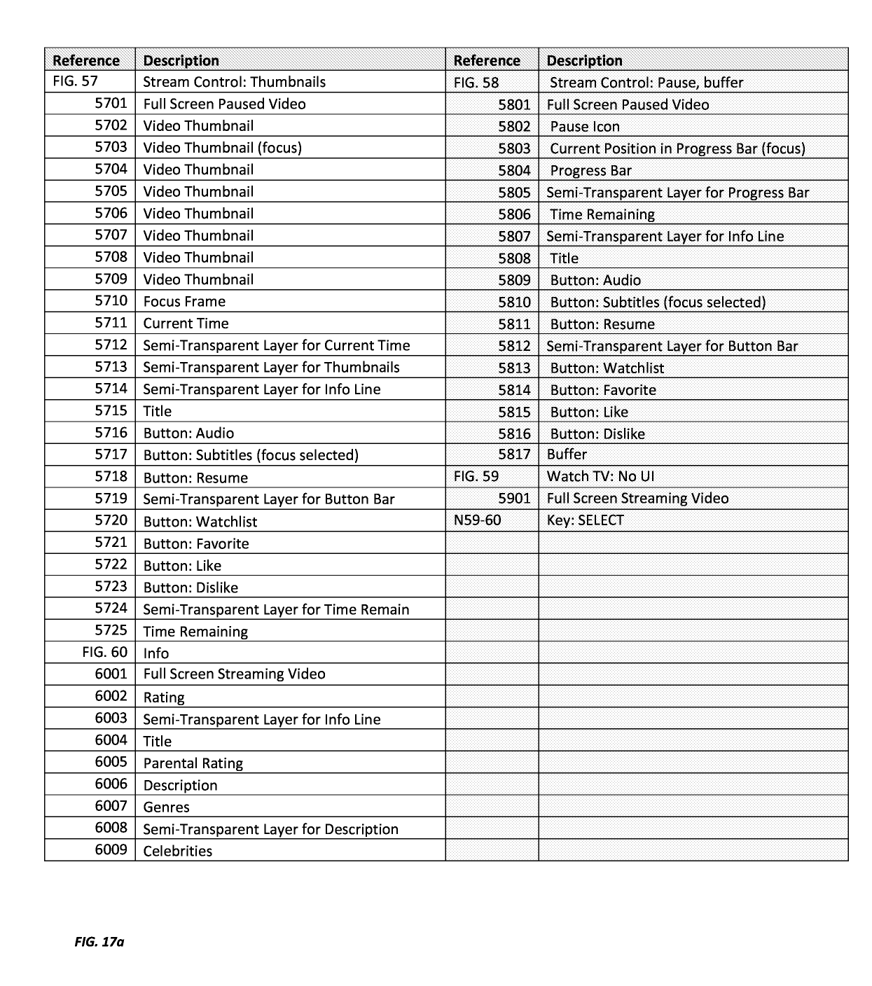

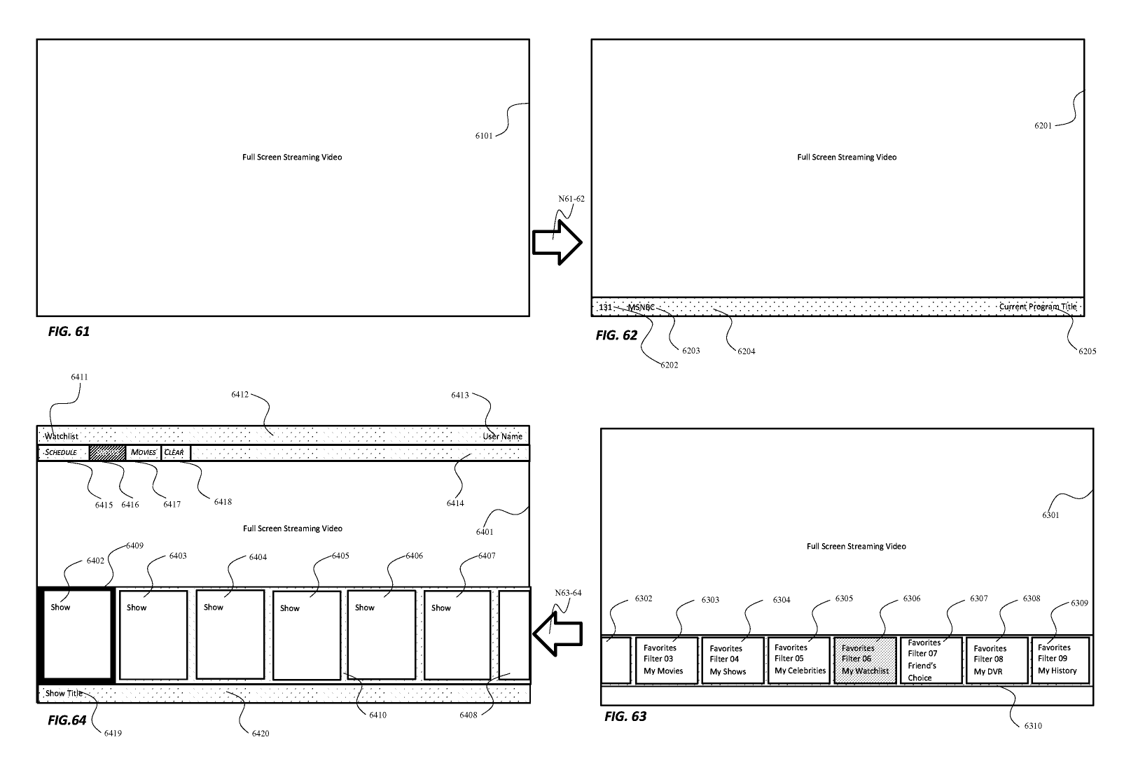

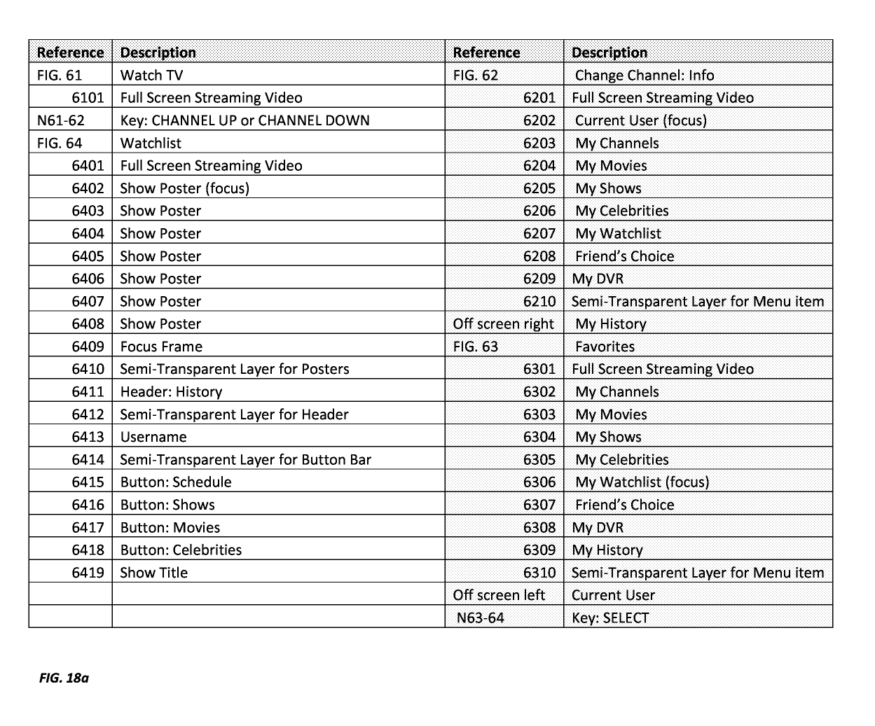

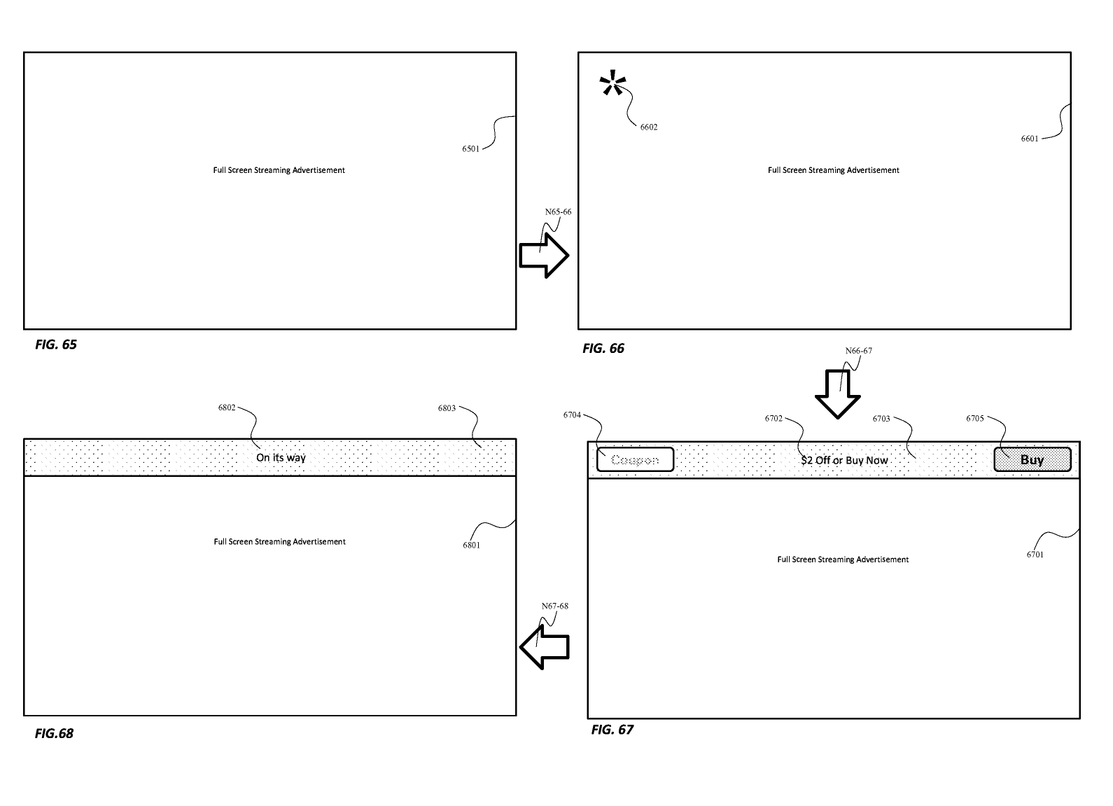

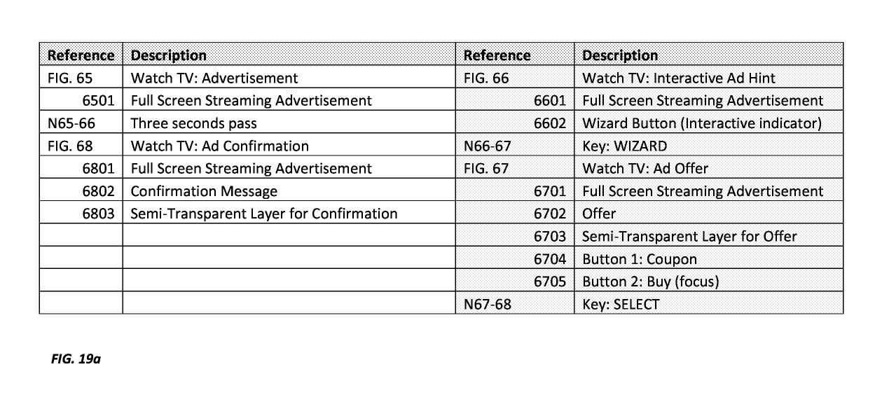

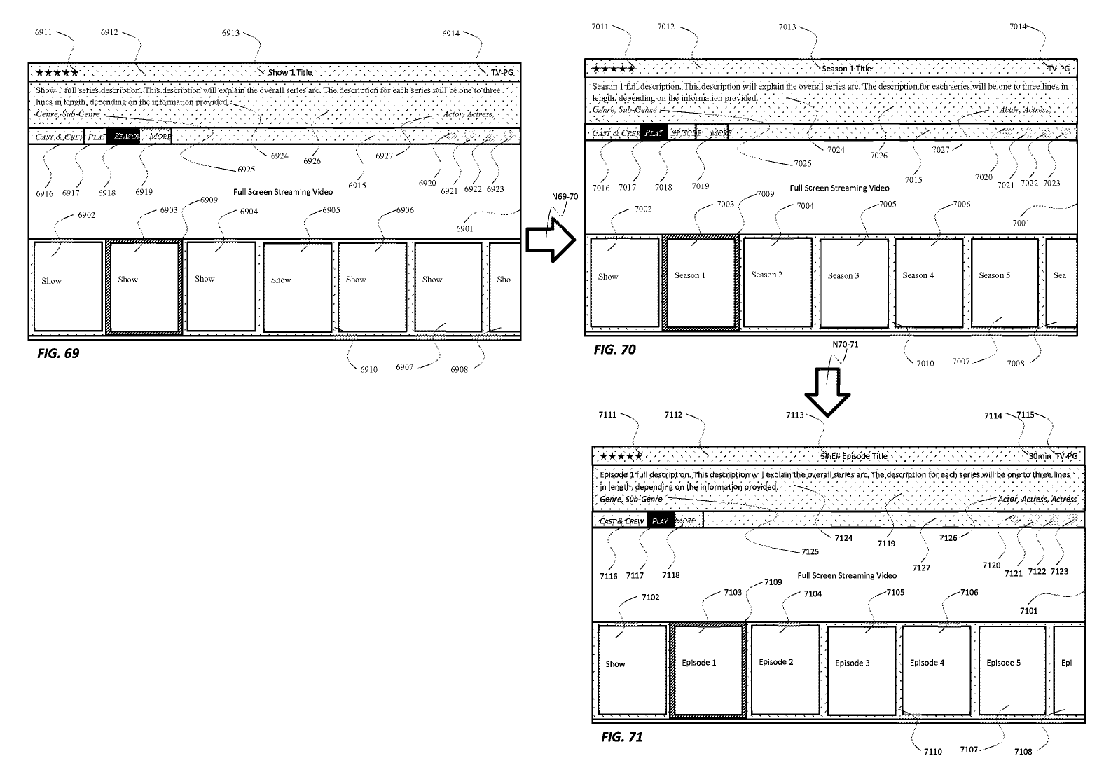

FIG. 8a Describes an embodiment of User Interface Elements and Navigation flow for the main, show, my show library, and show library extended information screens.

FIGS. 26-29 Show an embodiment of show library extended information, season, episode, and episode extended information screens.

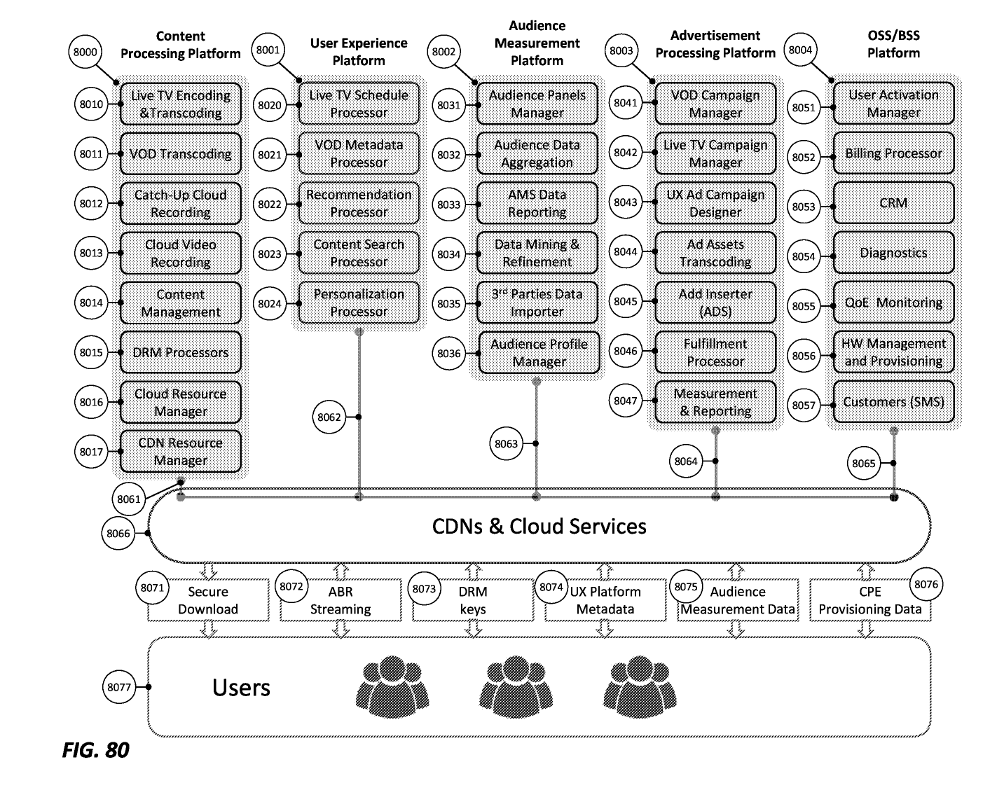

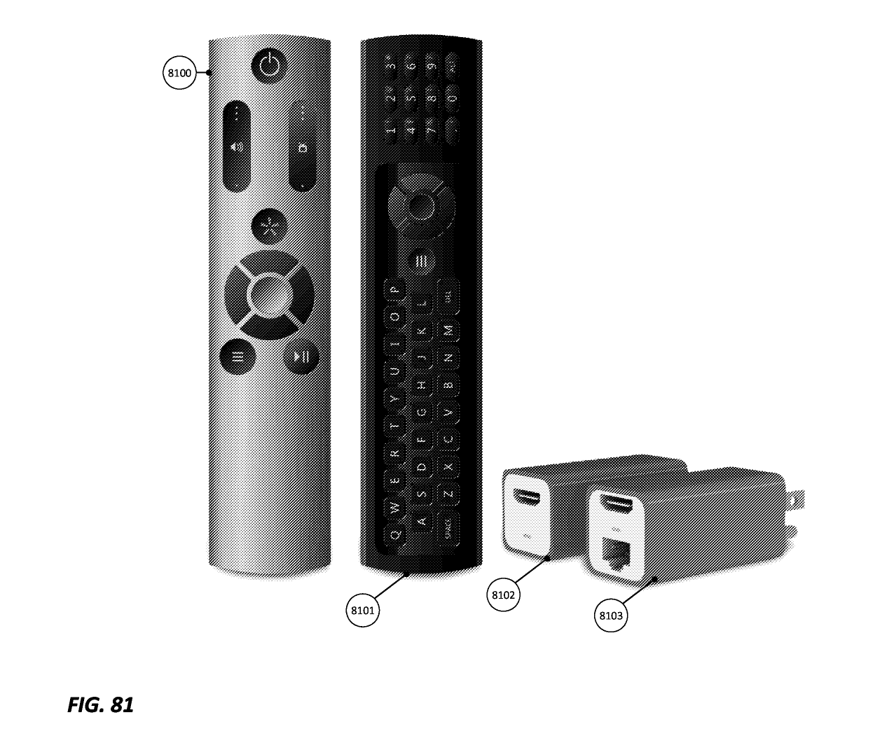

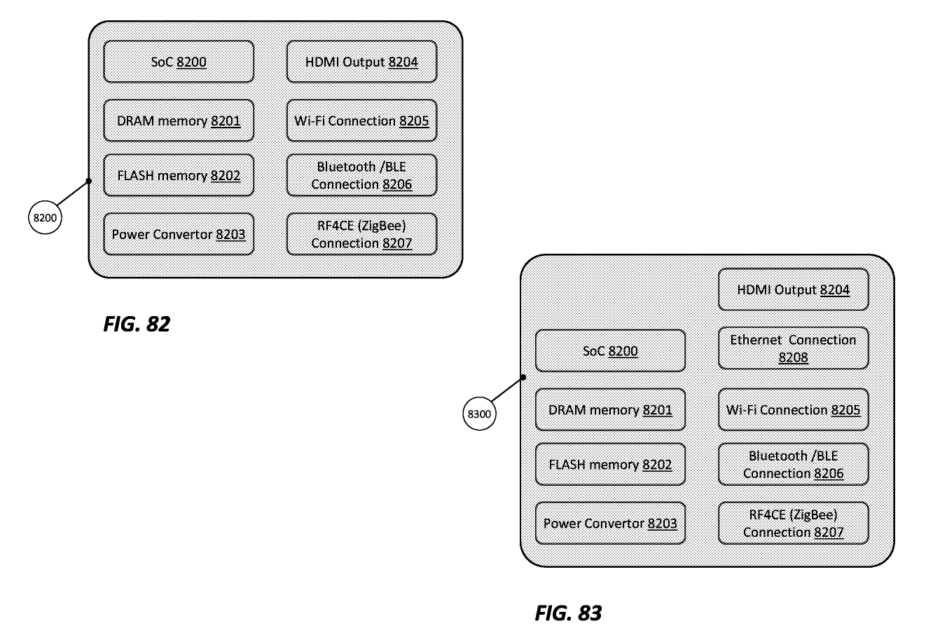

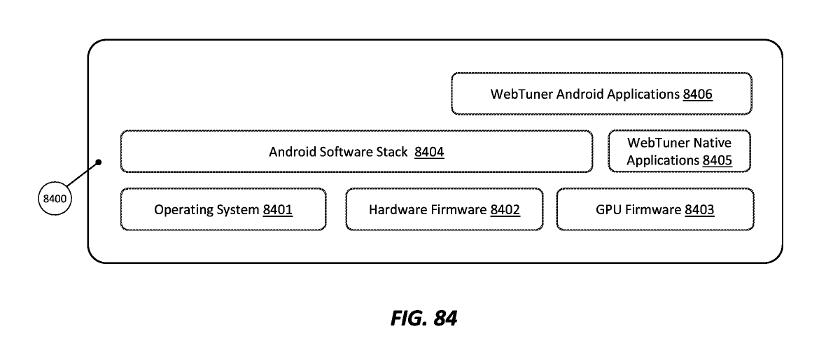

FIG. 9a Describes an embodiment of User Interface Elements and Navigation flow for the show library extended information, season, episode, and episode extended information screens.

FIGS. 30-33 Show an embodiment of channel, play, stream control no thumb pause, and stream control no thumb fast forward (FF) screens.

FIG. 10a Describes an embodiment of User Interface Elements and Navigation flow for the channel, play, stream control no thumb pause, and stream control no thumb FF screens.

FIGS. 34-37 Describes an embodiment of main, sports, main, and extras screens.

FIG. 11a Describes an embodiment of User Interface Elements and Navigation flow for the main, sports, main, and extras screens.

FIGS. 38-41 Describes an embodiment of main, favorites, navigation to history, and history screens.

FIG. 12a Describes an embodiment of User Interface Elements and Navigation flow for the main, favorites, navigation to history, and history screens.

FIGS. 42-45 Describes an embodiment of main, celebrities, search, and results screens.

FIG. 13a Describes an embodiment of User Interface Elements and Navigation flow for the main, celebrities, search, results.

FIGS. 46-49 Describes an embodiment of movie library, movie library extended information, and movie library extended browsing screens, and a second view of the movie library extended browsing screen after a right button is pressed three times.

FIG. 14a Describes an embodiment of User Interface Elements and Navigation flow for movie library, movie library extended information, and movie library extended browsing screens.

FIGS. 50-53 Describes an embodiment of schedule, schedule extended watchlist, and watch toggle screens and the watch toggle screen after a right button is pressed once.

FIG. 15a Describes an embodiment of User Interface Elements and Navigation flow for the schedule, schedule extended watchlist, and watch toggle screens.

FIGS. 54-56 Describes an embodiment of main, avatar, and main screens.

FIG. 16a Describes an embodiment of User Interface Elements and Navigation flow for the main, avatar, and main screens.

FIGS. 57-60 Describes an embodiment of stream control thumbnails, buffer stream control, watch tv, and information screens.

FIG. 17a Describes an embodiment of User Interface Elements and Navigation flow for the stream control thumbnails, buffer stream control, watch TV, information screens.

FIGS. 61-64 Describes an embodiment of favorites, watchlist, watch TV, and change channel screens.

FIG. 18a Describes an embodiment of User Interface Elements and Navigation flow for the favorites, watchlist, watch TV, change channel screens.

FIGS. 65-68 Describes an embodiment of watch TV, ad prompt, ad offer, and ad confirmation screens.

FIG. 19a Describes an embodiment of User Interface Elements and Navigation flow for the watch TV, ad prompt, ad offer, and ad confirmation screens.

FIG. 69-71 Describes an embodiment of show library extended information, season extended information, and episode extended information screens.

FIG. 80 Depicts an embodiment of a diagram of the system of the invention.

FIG. 81 Depicts embodiments of a remote control and television adapters that can be used with the methods and systems of the invention.

FIGS. 82-83 Depict various embodiments of the components of the television adapter embodiments.

FIG. 84 Depicts an embodiment of software components of an aspect of the invention.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms.

Therefore, there is no intent that specific structural and functional details should be limiting, but rather the intention is that they provide a basis for the claims and as a representative basis for teaching one skilled in the art to variously employ the present invention

Embodiments described herein are directed to systems and methods for processing, compression, transmission, storage, decompression, rendering and user interaction with video/audio content and content metadata. This systems and methods simplify the way a user will find relevant content and interact with it. That system and method include, for example a Personalized User Interface, a Personalized Recommendation Processor/Engine, a Unified Search Service and User Interface (through Linear TV, Movies, TV Shows, and Celebrities), an Audience Measurement Platform, an Addressable Interactive Advertisement Platform and User Interface, and a TV Adapter and Remote.

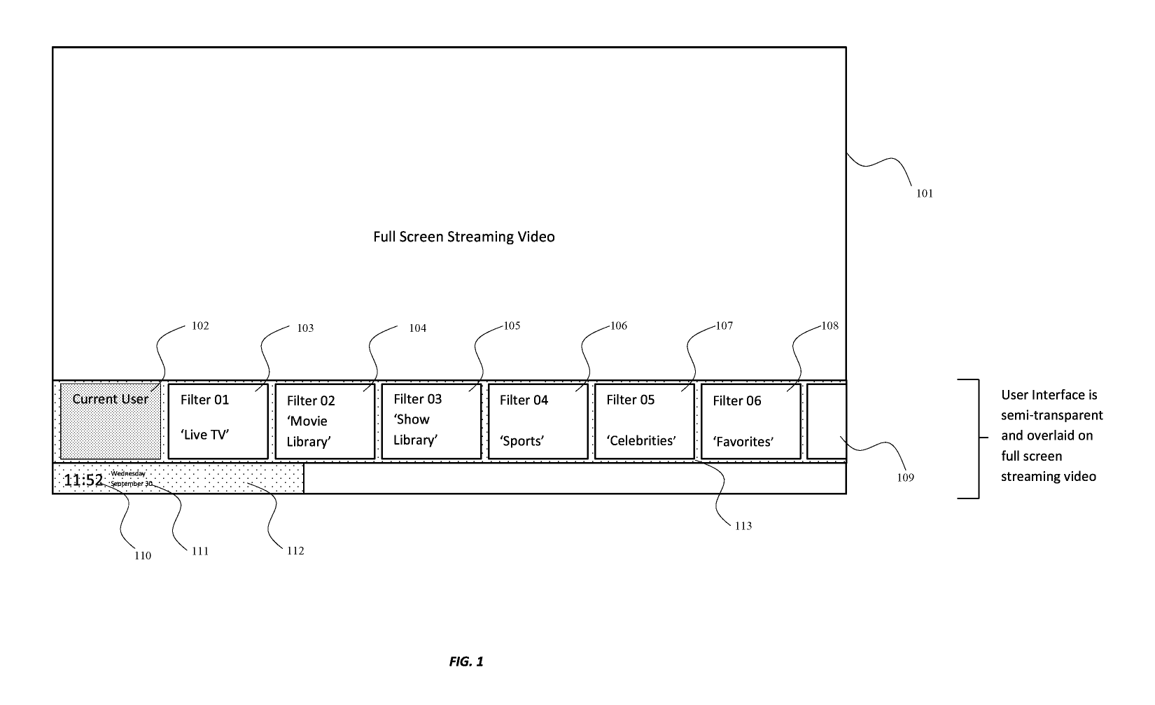

FIGS. 1-71 depict various embodiments of screens shots of the user interface of the invention described herein. For example, FIG. 1 depicts a preferred embodiment of a Main Menu screen shot, FIG. 24 depicts a preferred embodiment of a Favorite Show List screen shot, FIG. 35 depicts a preferred embodiment of a Sports Menu screen shot, and FIG. 50 depicts a preferred embodiment of a Live TV Channel Schedule screen shot. Additionally, FIGS. 1-71 show various preferred embodiments of the changes in screens as a user navigates the user interface. The “a” figures define the elements depicted in FIGS. 1-71.

FIG. 1 depicts an embodiment of a home screen or main menu of the inventive user interface (UI). Preferably, the user interface is semi-transparent and overlaid 113 on the full screen playing video 101. Parts of the UI described as semi-transparent may alternatively be opaque, transparent, solid, or another translucency. Preferably each menu and submenu is overlaid on a full screen playing video without blocking the view of the whole video. Video 101 can be a streaming video (e.g. from an Internet service), IPTV (internet protocol TV), a previously recorded (DVR) video, a currently broadcasted video (e.g. over terrestrial signals, cable networks, or satellite networks), from a set-top-box (STB), from a BluRay player, or another video source. Preferably the UI is displayed as a strip of boxes, icons, or mosaic elements along a lower portion of the device displaying the UI. However the UI can be located at a different location, in a different configuration, or have different elements.

Preferably each user of the UI has an avatar. The avatar can be chosen by the user, assigned by the system, or otherwise obtained. Preferably, during use of the UI, the user's avatar is depicted 102 on the UI to provide a reference to the user that the user is using the correct UI. For example, as described herein, each user can customize the UI to their tastes. Preferably, the viewers can change which user the UI is providing content for. For example, FIG. 54-56 depict an embodiment of the navigation of switching from User 4 to User 2. Preferably, each box is related to a different category of available media. For example box 103 may be related to live TV, box 104 may be related to a movie library, box 105 may be related to sports programs, box 107 may be related to celebrities, and box 108 may be related to the user's favorites. Preferably the UI may extend further than can be shown on the display device at once. For example box 109 is only partially shown. Additional boxes (related to different categories of media content) may be viewable by scrolling the UI. Preferably, the number of boxes shown at one time on the display device are at least one of chosen by the user, automatically chosen based on the display device's characteristics (e.g. size, resolution, and orientation), fixed by the system. Each screen of the UI may have the same number of boxes displayed at a time or a different number of boxes displayed at a time from another screen of the UI. Each box may display video, a picture, text, or a combination thereof related to the category thereof. Preferably, the UI seamlessly integrates multiple content sources into the program guide. For example, if a user is looking for a movie, the UI may provide options from live TV, on-demand, a streaming service (e.g. Netflix or Amazon), DVR, and/or other sources without the user being aware of the source of the content.

Preferably, the UI also displays the current time 110 and date 111 in a semi-transparent layer 112. Additional information may also be displayed in semi-transparent layer 112, for example a company's logo, weather reports, stock reports, news headlines, or other information.

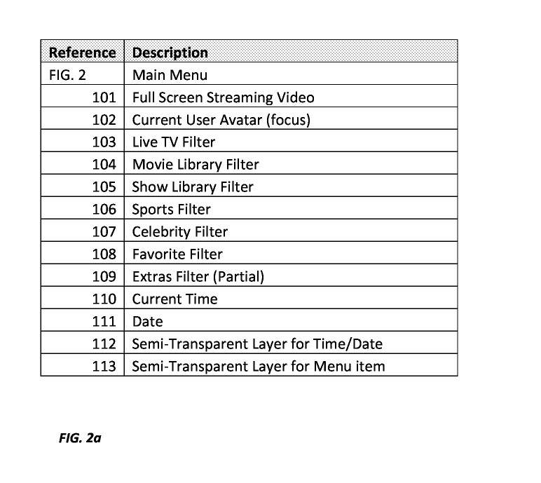

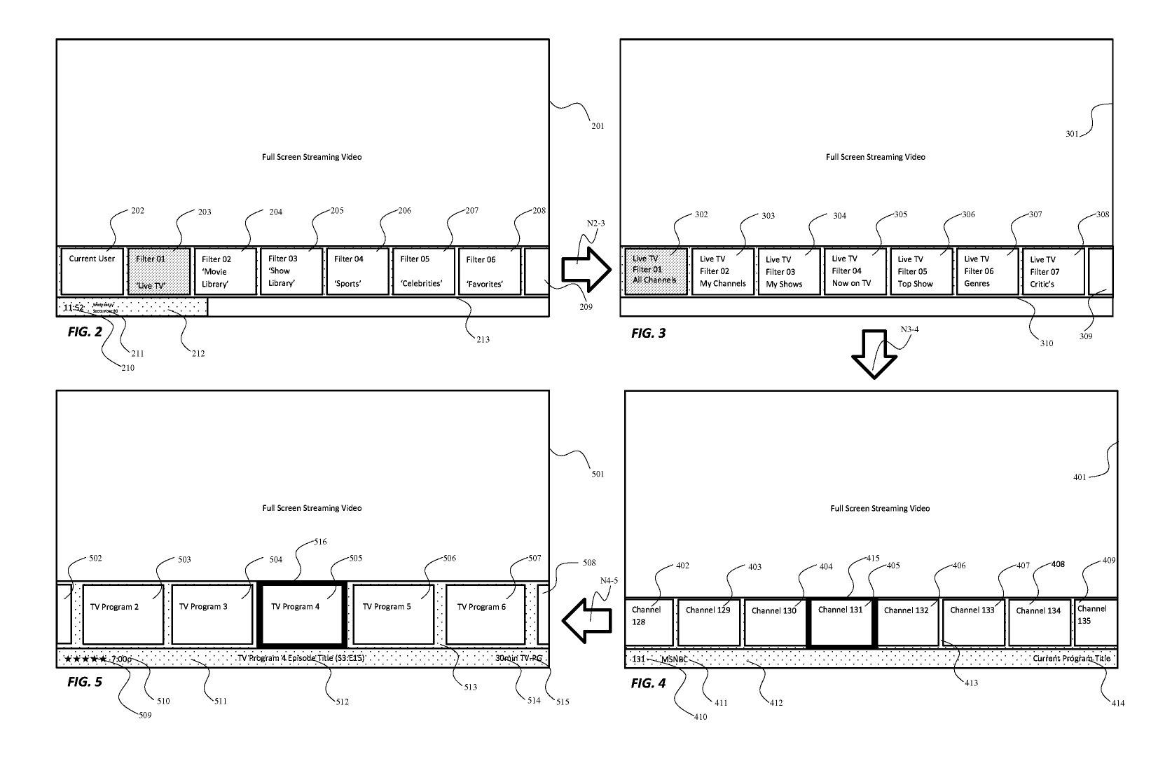

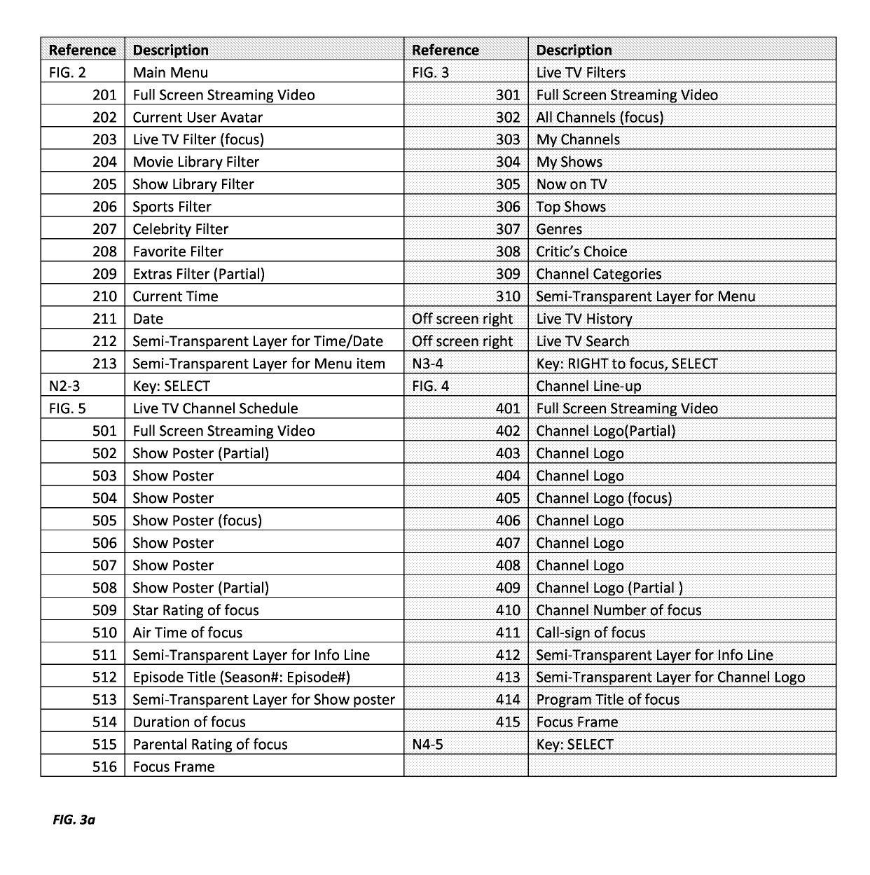

FIGS. 2-4 depict an embodiment of the navigation or flow through the UI. Upon initiating the UI, the user is presented with the home screen shown in FIG. 2. Upon selecting a box (in this example Live TV 203), for example with a remote control, the UI changes to a first submenu associated with the chosen box (in this example a live TV submenu 310), as shown in FIG. 3. Preferably the first box of first submenu 310 indicates the chosen category (in this example live TV box 302). The user is preferably presented with a number of subcategory options (in this example, my channels (e.g. the user's preferred channels) 303, my shows (e.g. the user's preferred shows) 304, now on TV (e.g. the shows currently available) 305, top shows (e.g. the highest rated shows) 306, genres 307, critics choice 308, and/or other options 309). Other options may include channel categories, TV history (e.g. the channels the user has viewed in the past), and TV searches (e.g. searches the user has conducted). Preferably each box of the second submenu displays a picture, video, and/or words related to the option associated therewith. Once the user chooses an option from the first submenu, the UI changes to a second submenu associated with the chosen option from the first submenu (in this example a channel line-up submenu 413), as shown in FIG. 4.

Preferably the second submenu presents the user with another set of options. In the example depicted in FIG. 4, each option is associated with a different channel (e.g. channels 128-135 are respectively associated with boxes 402-409). Preferably as the user scrolls to the right or left more options appear and currently visible options disappear from view. Preferably each box of the second submenu displays a picture, video, and/or words related to the option associated therewith. For example, each box may display the logo of the associated channel. Preferably, the second submenu also displays information related to a highlighted or focused box 415. The information may be displayed in a semi-transparent information line 412 and include, for example, the channel number 410, the channel call-sign 411, and the title of the program currently playing on the channel 414. Once the user chooses an option from the second submenu, the UI changes to a third submenu associated with the chosen option from the second submenu (in this example a live TV channel schedule submenu 513), as shown in FIG. 5.

Preferably the third submenu presents the user with another set of options. In the example depicted in FIG. 5, each option (e.g. boxes 502-508) is associated with a different show available on the selected channel. Preferably as the user scrolls to the right or left more options appear and currently visible options disappear from view. Preferably each box of the third submenu displays a picture, video, and/or words related to the option associated therewith. For example, each box may display a poster of the associated show. Preferably, the third submenu also displays information related to a highlighted or focused box 516. The information may be displayed in a semi-transparent information line 511 and include, for example, the star rating 509, air time 510, episode title 512, show duration 514, and parental rating 515. Once the user chooses an option from the third submenu, chosen show is displayed in full screen 501.

Alternatively, the user may choose to find out more information about the highlighted live TV program. FIGS. 6-8 depict an embodiment of additional navigation through the UI. Note FIGS. 5 and 6 depict the same submenu. Upon selecting to receive more information about an option, the UI may change to an extended information menu as depicted in FIG. 7. The extended information menu may have a semi-transparent information line 712 that includes, for example, the star rating 710, air time 711, episode title 713, show duration 714, and parental rating 715. The extended information menu may additionally have a semi-transparent description layer 721 that includes the show's description 716, genre 717, and the actors/actresses in the show 718. Additionally, extended information menu may have a semi-transparent button bar that has buttons the user can select to, for example, obtain more information about the cast and crew 719, play the show 720, find out more information 721, add the show to the user's watchlist 724, add the show to the user's favorites 725, and/or indicate that the user likes the show 726 or dislikes the show 727 (e.g. for social media purposes or recommendation purposes).

If the user, for example selects the cast and crew button 719, the UI may change to a celebrity extended information menu as depicted in FIG. 8. The celebrity extended information menu may provide a list of cast and crew in the selected program (indicated by box 802) for which more information is available (e.g. boxes 803-808). Preferably each box displays a picture, video, and/or words related to the actor, actress, or other person associated therewith. Upon selecting, for example, the actress associated with box 804, the UI preferably provides information related to that actress as depicted in FIG. 9. The UI may display an information line 912 that may include, for example, the person's birthday 911, name 913, and birthplace 914. The UI may also display another button bar 915 that includes buttons for the user to, for example, add the person as a favorite 916, display the shows the person is in 917, and/or display the movies the person is in 918.

FIGS. 10-12 depict an embodiment of the UI navigation of a user continuing to obtain more information. For example, in FIG. 10, the user may choose to see what shows the actor selected in box 1009 is in by pressing the shows button 1017. The UI preferably changes to depict the actor in box 1102 and the shows the actor is in (e.g. boxes 1103-1108), as depicted in FIG. 11. The user can then choose a show, for example 1109, to find more information about and the UI will preferably change to the show information display as depicted in FIG. 12. From there, the user can choose to view the cast and crew of the show by selecting the cast and crew button 1216, upon which, the UI will preferably change to the cast and crew display as depicted in FIG. 13. If the user selects a person, the UI will preferably change back to the actor information page depicted in FIG. 10. Preferably, the user can continue to find out more information about shows and people, as desired. The information may be stored locally in a database, be available over a network (e.g. the Internet), or be stored remotely in a database.

FIGS. 14-17 depict an embodiment of a user selecting the movie library option from the main menu. As depicted in FIG. 14, the user may select the movie library box 1404. Once selected, the UI preferably changes to a first submenu associated with the movie library, as shown in FIG. 15. The user is preferably presented with a number of subcategory options (in this example, top movies (e.g. the highest rated movies) 1502, my movies (e.g. the user's preferred movies) 1504, genres 1504, critic's choice 1505, movies available on TV 1506, movies available in theaters 1507, a movie search option 1508, and/or other options 309). Other options may include movie history (e.g. the channels the user has viewed in the past). Preferably each box of the second submenu displays a picture, video, and/or words related to the option associated therewith. Once the user chooses an option from the first submenu, the UI changes to a second submenu associated with the chosen option from the first submenu (in this example a genre submenu 1610), as shown in FIG. 16.

Preferably the second submenu presents the user with another set of options. In the example depicted in FIG. 16, each option is associated with a different genre (e.g. action/adventure 1602, animated 1603, comedy 1604, drama 1605, documentary 1606, horror 1607, kids 1608, and others 1609). Preferably as the user scrolls to the right or left more options appear and currently visible options disappear from view. Preferably each box of the second submenu displays a picture, video, and/or words related to the option associated therewith. Once the user chooses an option from the second submenu, the UI changes to a third submenu associated with the chosen option from the second submenu (in this example a comedy movie submenu 1714), as shown in FIG. 17.

Preferably the third submenu presents the user with another set of options. In the example depicted in FIG. 17, each option (e.g. boxes 1702-1709) is associated with a different movie available in the selected genre. Preferably as the user scrolls to the right or left more options appear and currently visible options disappear from view. Preferably each box of the third submenu displays a picture, video, and/or words related to the option associated therewith. For example, each box may display a poster of the associated movie. Preferably, the third submenu also displays information related to a highlighted or focused box 1710. The information may be displayed in a semi-transparent information line 1712 and include, for example, the star rating 1711, title 1713, duration 1715, and parental rating 1716. Once the user chooses an option from the third submenu, chosen movie is displayed in full screen 1701. Preferably, the movies are available from multiple sources for example, on live TV, on demand, recorded movies, a database of movies, streaming movies, and/or other sources.

FIGS. 18-20 depict an embodiment of the UI navigation of a user obtaining more information about a movie. Preferably, the UI for viewing more information about a movie is similar to viewing more information about a live TV show depicted in FIGS. 6-9. FIGS. 46-49 also depict an embodiment of the UI navigation of a user obtaining more information about movies. For example, in FIG. 46, a user may select a movie 4610 the user wants to find more information about. The UI preferably changes to a movie information screen shown in FIG. 47. If the user desires to find out information about another movie, the user can from, for example the play button (as depicted in FIG. 47) to the list of boxes providing movie options (as depicted in FIG. 48). The user can then scroll left or right to choose another movie to find out information about. For example, the user can choose the movie in highlighted box 4909 in FIG. 49 to view information about.

FIGS. 22-25 depict an embodiment of a user selecting the show library option from the main menu. Preferably, the UI for viewing the show library is similar to viewing movie library depicted in FIGS. 14-17. Additionally, in the button bar, for example depicted in FIG. 25, there may also be a season option 2618 to find out information about a show's various seasons. While the show library may include live TV options, preferably it also includes options for streaming shows, recorded shows, on-demand shows, and shows from other sources.

FIGS. 26-29 depict an embodiment of the navigation of a user obtaining more information about a show. FIG. 26 depicts an embodiment of a show information screen of the UI. The user may choose to view more information about the various seasons of a selected show (e.g. highlighted box 2609) by selecting the season button 2618. Preferably upon selecting season button 2618, the UI changes to the season menu 2710 depicted in FIG. 27. Season menu 2710 preferably has a first box 2702 indicating the chosen show and a plurality of additional boxes 2703-2708 for each season. While the example shown has at least six seasons, more or less seasons can be indicated. Preferably each box of the season menu displays a picture, video, and/or words related to the season associated therewith. Additionally, there may be an information line 2712 that includes, for example, the season's star rating 2711, the show's title 2713, and the parental rating 2714. Preferably, the user can choose a season to find out more information about. FIGS. 69-71 depict another embodiment of navigation through the UI to obtain more information about a show.

Upon selecting a season from the season menu 2710, preferably, the UI changes to an episode menu 2810, for example, depicted in FIG. 28. Episode menu 2810 preferably has a first box 2802 indicating the chosen show and a plurality of additional boxes 2803-2808 for each episode. While the example shown has at least six episodes, more or less episodes can be indicated. Preferably each box of the episode menu displays a picture, video, and/or words related to the episode associated therewith. Additionally, there may be an information line 2712 that includes, for example, the episode's star rating 2711, the show's title 2713, the episode's duration 2815, and the parental rating 2714. Preferably, the user can choose an episode to find out more information about. Upon selecting an episode from the episode menu 2810, preferably, the UI changes to an episode information menu, for example, depicted in FIG. 29, which is the similar UI page shown in FIG. 25 but specific to the chosen episode.

FIGS. 30-33 depict an embodiment of the UI used to control a video. In FIG. 30, a user is able to choose a live TV show to watch, for example channel 131 in highlighted box 3015. While the embodiment depicted in FIGS. 30-33 show live TV the same controls are available for other types of media content. Once chosen, the currently broadcasted show is shown full screen 3101, as depicted in FIG. 31, without any overlays. The user may be able to pause (as shown in FIG. 32), fast forward (as shown in FIG. 33), rewind, or otherwise control the play of the video. Preferably, when paused, a pause menu appears as an overlay on the full screen video. The pause menu may include, for example, an information line 3207 with the show's title 3208; a button layer with buttons, for example, for choosing audio controls 3209, subtitles 3210, to resume the show 3211, to add the show to a watch list 3213, to add the show to the user's favorites 3214, and/or to like 3215 and dislike 3216 the show; and a progress bar line that may include a pause icon 3202, the progress bar 3204 with the current position in the show indicated 3203, and the time remaining in the show 3206. For streaming videos, as depicted in FIG. 58, the progress bar may additionally show a buffer of available video 5817. For example the system may continue to download the video stream while the video is paused.

Preferably, when the video playback is fast forwarded (or rewound), a fast forward menu appears as an overlay on the full screen video. The fast forward menu is similar to the pause menu with the icon 3302 indicating fast forward and the addition of a current time bar 3318 indicating the current time 3317 of the fast forwarding. Alternatively, the UI may depict thumbnails of the video during fast forwarding and rewinding, as depicted in FIG. 57. Frames 5702-5709 are preferably thumbnails of points in the video that can be fast forwarded or rewound to. Preferably, as the user continues to fast forward or rewind, frames that are off the screen come into view and frames on the screen disappear from view.

FIGS. 34 and 35 depict an embodiment of the navigation through the sports 3406 submenus. Once a user chooses to view the sports options from the main menu, as depicted in FIG. 34, the UI preferably changes to a sports submenu 3508, as depicted in FIG. 35. The sports submenu preferably has one box 3502 indicating that the submenu is for sports programming and then a number of boxes (3503-3507) depicting the various types of sports available for viewing. Preferably, once a user chooses a type of sport, the UI will change to another submenu that shows the available games for viewing for the chosen sport.

FIGS. 36 and 37 depict an embodiment of the navigation through an extras 3709 submenu. Once a user chooses to view the extras options from the main menu, as depicted in FIG. 37, the UI preferably changes to an extras submenu 3610, as depicted in FIG. 36. The extras submenu preferably has a number of boxes (3503-3509) depicting the various extras available for viewing. Extras may include, but are not limited to, various information provided from the Internet (e.g. weather 3602 and news), video on demand 3604, music applications (e.g. internet radio 3605 and music videos 3606), other content 3607, user history 3608, settings 3609, web browsing, games, and other applications. Preferably, once a user chooses an extra, the UI will change to another submenu that shows what is available for viewing for the chosen extra or will show the chosen extra full screen 3601.

FIGS. 38-41 depict an embodiment of the navigation through the favorites 3808 submenus. Once a user chooses to view the favorites 3808 options from the main menu, as depicted in FIG. 38, the UI preferably changes to an favorites submenu 3910, as depicted in FIGS. 39 and 40. The favorites submenu 3910 preferably has a first box 3902 that indicates the current user and several additional favorites options. For example, the favorites options may include, but are not limited to, the user's channels 3903, the user's movies 3904 and 4003, the user's shows 3905 and 4004, the user's celebrities 3906 and 4005, the user's watchlist 3907 and 4006, recommendations from the user's friends or other people 3908 and 4007, the user's DVR recorded shows 3909 and 4008, and the user's history 4009. Preferably the favorites are populated by selections made by the user while browsing the available media content. For example from selections of the favorite (as depicted in FIG. 51) or watchlist (as depicted in FIG. 53) buttons in the UI. Preferably the favorite and watchlist buttons can be found on the extended information pages of the UI, however the buttons may be on other pages, on the remote control, or otherwise located. Preferably, once a user chooses a favorite option, the UI will change to another submenu that shows what is available for viewing for the chosen favorite, for example the user's history as shown in FIG. 41. The history submenu preferably includes a history header that includes the “History” title 4111 and the user's name 4113. The user may preferably be able to select various buttons in a button bar 4114. For example, the user may select to see the schedule history 4155, the shows history 4166, the movies history 4117, the celebrities history 4118, or to clear the user's history 4119. Depending on the button selected the UI preferably depicts boxes related to the user's history of the option chosen (shows in the example depicted in FIG. 41). The UI may additionally include information about the history (e.g. a show's title 4121). Similarly, as depicted in FIGS. 63 and 64, if a user chooses to view their watchlist, a watchlist submenu will appear. Preferably, the user can view the various shows (via button 6416) and movies (via button 6417) that the user has saved to watch later, which preferably appear in boxes on the UI. Additionally, the user can choose to clear their watchlist via button 6418.

FIGS. 42-45 depict an embodiment of navigation through the celebrities 4207 menus. Once a user chooses to view the celebrities 4207 options from the main menu, as depicted in FIG. 42, the UI preferably changes to a celebrities submenu 4308, as depicted in FIG. 43. The celebrities submenu 4308 preferably has a number of celebrities related options. For example, the favorites options may include, but are not limited to, top celebrities 4302, the user's favorite celebrities 4303, award winners 4304, celebrities in the news 4305, a search option 4306, and the user's history 4307. Preferably, once a user chooses a celebrities option, the UI will change to another submenu that shows what is available for viewing for the chosen celebrities option, for example the a search option as shown in FIG. 44. The search submenu preferably includes a search bar 4405 that contains a search query 4402, a search filed 4403 and a results number 4404. Preferably, as a user enters search terms, the system automatically guesses the search that the user wishes to perform, as shown in FIG. 45. The system may offer options to select as the user types or provide search results based on the letters entered. For example, as shown in FIG. 45, the UI may display a number of boxes 4502-4508 that have the same letters (“JULIA” as depicted in the figure) as the search terms. The boxes may show pictures, videos, and/or text related to celebrities that match the search terms. There may also be a bar 4511 that displays the celebrity's name 4512 of the highlighted search result 4509. The user may preferably be able to select various buttons in a button bar 4411. For example, the user may select to search the schedule of shows 4406, shows 4407, movies 4408, celebrities 4409, and the user's history 4410.

Preferably, from the full screen viewing, as depicted in FIG. 59, the user can choose to obtain information about the currently showing video, for example, by pressing a button on the remote control. Upon selecting to see information about the video, the UI preferably presents the information as an overlay on the video as shown in FIG. 60, for example. Additionally, from the full screen view, the user can choose to change a channel (e.g. by pressing a button on the remote control). As the user changes channels, the UI preferably presents the user with information about the new channel as depicted in FIGS. 61 and 62.

FIGS. 65-68 depict an embodiment of the navigation of using an interactive option of the system. From the full screen video displayed in FIG. 65, the video may have an interactive icon 6602 as depicted in FIG. 66 alerting the viewer that the show, advertisement, or other video has an interactive aspect to it. The user can choose to interact with the video, for example by pressing an associated button on the remote control. Once the user chooses to interact with the video, an interactive layer 6703 may appear over the video as depicted, for example, in FIG. 67. The interactive layer 6703 may, for example, have an offer 6702, a coupon button 6704, and a buy button 6705. If the user chooses to get the offer, the UI may display a confirmation 6802, as depicted in FIG. 68.

FIG. 80 depict an embodiment of the system. Preferably, the system comprises a content processing platform 8000, a user experience platform 8001, an audience measurement platform 8002, an advertisement processing platform 8003, and an operation support system (OSS) and business support system (BSS) platform 8004. The content processing platform 8000 preferably includes live TV encoding and transcoding 8010, VOD transcoding 8011, a catch-up cloud recording 8012, a cloud video recording 8013, a content management 8014, a DRM (digital rights management) processors 8015, a cloud resource manager 8016, and a CDN (content delivery network) resource manager 8017. The experience platform 8001 preferably includes a live TV schedule processor 8020, a VOD metadata processor 8021, a recommendation processor 8022, a content search processor 8023, a personalization processor 8024. The audience measurement platform 8002 preferably includes an audience panels manager 8031, an audience data aggregation module 8032, an AMS (audience measurement system) data reporting module 8033, a data mining and refinement module 8034, a 3^{rd} parties data importer 8035, and an audience profile manager 8036. The advertisement processing platform 8003 preferably includes a VOD campaign manager 8041, a live TV campaign manager 8042, an UX (user experience) ad campaign designer 8043, an ad asset transcoding module 8044, an ad inserter (ADS) 8045, a fulfillment processor 8046, and a measurement and reporting module 8047. Preferably the OSS/BSS platform 8004 includes a user activation manager 8051, a billing processor 8052, a CRM (consumer relationship management) module 8053, a diagnostics module 8054, a QoE (quality of experience) monitoring module 8055, a hardware management and provisioning module 8056, and a customers (SMS) module 8057.

Each of the content processing platform 800, user experience platform 8062, audience measurement platform 8002, advertisement processing platform 8064, and OSS/BSS platform are in two way communication with a CDN and cloud service module 8066. Preferably the UI 8077 receives secure downloads 8071 from the CDN and cloud services module 8066 and is in two way communication with the CDN and cloud services module 8066 for ABR (adaptive bit rate) streaming 8072, DRM keys 8073, UX platform metadata 8074, audience measurement data 8075, and CPE (consumer premises equipment) provisioning data 8076.

FIG. 81 depicts preferred embodiments of a computing device (8102 or 8103) of the current invention and a corresponding input device 8100 and 8101. In the preferred embodiment the computing device is a streaming media device. Embodiments of the basic hardware components of the computing device can be found in FIGS. 82 and 83 and an embodiment of the basic software components of the computing device can be found in FIG. 84. The device preferably includes a power converter. For example, the power converter may convert from alternating current (AC) to direct current (DC). Preferably, the power converter accepts 120 volts at 60 hertz; however the power converter may be adapted to another standard international voltage. The power converter preferably includes blades to mate with an electrical outlet. Additionally, as described herein, the blades may provide for heat dissipation. The power converter is preferably polarized and may include a grounding blade. Additionally, the power converter may be adapted to be used in another standard international outlet.

The power converter is used to supply power to the remaining components of the streaming media device. The streaming media device further includes an integrated circuit (i.e. a system on a chip (SoC)). The SoC integrates multiple components of a computer or other electronic system into a single chip. It may contain digital, analog, mixed-signal, and radio-frequency functions all on a single chip substrate. The SoC preferably incorporates a central processing unit (CPU), a graphics processing unit (GPU), and a system bus that couples various system components including the system memory, dynamic random access memory (RAM) and flash memory, to the SoC. The system bus may be one of several types of bus structures including a memory bus or memory controller, a peripheral bus, or a local bus using one of a variety of bus architectures. A basic input/output (BIOS) stored in flash memory or the like, may provide the basic routine that helps to transfer information between elements within the computing device, such as during start-up. The drives and the associated computer readable media provide nonvolatile storage of computer readable instructions, data structures, program modules and other data for the computing device. The basic components are known to those of skill in the art and appropriate variations are contemplated.

Although the exemplary environment described herein employs flash memory, it is appreciated by those skilled in the art that other types of computer readable media which can store data that are accessible by a computer, such as magnetic cassettes, hard drives, digital versatile disks, cartridges, random access memories (RAMs), read only memory (ROM), a cable or wireless signal containing a bit stream and the like, may also be used in the exemplary operating environment.

The computing device preferably further includes a networking device. The networking device is able to connect to, for example, the Internet, one or more Local Area Networks (“LANs”), one or more Metropolitan Area Networks (“MANs”), one or more Wide Area Networks (“WANs”), one or more Intranets, etc. Preferably the networking device is a Bluetooth device, other networking devices can be used. The networking device may be capable of connecting to wireless Bluetooth devices (e.g. a keyboard or a mouse). A second networking device may be a wireless networking device (e.g. Wi-Fi), however hard wired networks can be coupled to networking device 106 (e.g. eathernet). The networking device may also connect to distributed computing environments where tasks are performed by local and remote processing devices that are linked (either by hardwired links, wireless links, or by a combination thereof) through a communications network. In a distributed computing environment, program modules may be located in both local and remote memory storage devices.

To enable user interaction with computing device 8102 or 8103, there is an input receiving device 8100 and 8101. Input receiving device 8100 and 8101 can receive input from a number of input mechanisms, such as a microphone for speech, a touch-sensitive screen for gesture or graphical input, a keyboard, a mouse, motion input, RJ-45, USB, and so forth. In some instances, multimodal systems enable a user to provide multiple types of input to communicate with the computing device. There is no restriction on the invention operating on any particular hardware arrangement and therefore the basic features here may easily be substituted for improved hardware or firmware arrangements as they are developed.

The computing device further preferably includes at least one output port. The output port connects the computing device to a TV, speaker, projector, or other audio visual device. Preferably, the output port is a HDMI port, optical audio port, serial port, USB port, networking port, s-video port, coaxial cable port, composite video, composite audio, and/or VGA port. In preferred embodiments, the computing device may also include additional auxiliary components (e.g. power management devices or digital audio convertors).

This invention offers systems and methods for effective ad targeting and content recommending enabled by increased accuracy, speed, and number of viewer identifications. This invention identifies viewers by combining and processing passively obtained viewer behaviometrics measurement data with data from an Audience Measurement System (AMS).

Passively obtained behaviometrics measurement data is preferably collected by a remote control. The passively obtained behaviometrics measurement data can include, but is not limited to, changes in spatial positioning of the remote control, motion of the remote control, force with which the viewer pressed keys (such force can be collected by force sensors embedded into the remote control buttons), viewer's fingerprint recognition (e.g. from an optical, ultrasonic, or capacitance sensor embedded into one or more of the remote control buttons), or a viewer's spatial positioning and motion (e.g. obtained by one or more proximity sensors or a low resolution optical sensor embedded into a television, set top box, or other viewer facing device). The behaviometrics measurement data is obtained passively, without a viewer actively providing the behaviometrics measurement data or entering information. For example, the viewer does not have to actively and consciously swipe their finger over a fingerprint reader, type in a user identifier, or provide a voice sample.

The behaviometrics measurement data is preferably combined with a viewer's AMS data which comprises content, ad, and product consumption data as well as any product ordering data. For example, the AMS can collect data on what viewer consumed or ordered the content (e.g. correlated to content, ad, or product unique identifier), when the viewer consumed or ordered the content (e.g. by logging a timestamp of a beginning of the content consumption, the content's duration, and logging a timestamp and duration of an ordered product), actions taken by the viewer (e.g. volume up or down, mute, fast forward, pause, or other key presses related to product placement, product promotions, or product purchases).

Combining the behaviometrics measurement data with data from the AMS via known data mining and data processing algorithms provides substantially improved accuracy, speed, and number of positive viewer identifications over existing systems. The instant system is preferably able to more effectively generate ad revenue from targeted ad placement, affiliated fees received from product related transactions, and sales of premium content over existing systems.

While the examples provided herein are for TV viewing systems, the invention is also applicable to other video and audio applications, including, but not limited to, video viewing on PCs, tablets, smart phones, game consoles, radio receivers, MP3 players, and other streaming and linear programming devices.

Although the exemplary environment described herein employs a hard disk database, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Networks may include the Internet, one or more Local Area Networks (“LANs”), one or more Metropolitan Area Networks (“MANs”), one or more Wide Area Networks (“WANs”), one or more Intranets, etc. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A system for displaying a user interface (UI) on a display device, comprising:
a computing device coupled to the display device;
a controller adapted to provide instructions to the computing device; and
software executing on the computing device, wherein the software is adapted to, as an overlay on a full screen video:
display a main menu, the main menu comprising a first plurality of icons in a strip, one icon displaying a reference to a current user and at least one other icon displaying a reference to a category;
receive a selection of one of the first plurality of icons;
display a first submenu associated with the selected icon, the first submenu comprising a second plurality of icons in a strip; and
wherein the first submenu replaces the main menu upon the selection of the icon;
receive a selection of one of the second plurality of icons;
at least one of display a second submenu and change the full screen video based on the selection of one of the second plurality of icons.

2. The system of claim 1, wherein there are a plurality of other icons in the main menu, each displaying a reference to a different category.

3. The system of claim 1, wherein the category is at least one of live TV, movie library, show library, sports, celebrities, favorites, and extras.

4. The system of claim 1, wherein each icon of the main menu is associated with a different first submenu.

5. The system of claim 1, wherein there are additional submenus associated with each selection, each submenu comprising a plurality of icons in a strip and each icon displaying a different option for that submenu.

6. The system of claim 5, wherein at least one additional submenu provides information about a selected icon.

7. The system of claim 6, wherein the information is related to at least one of a selected show, a selected movie, and a selected celebrity.

8. The system of claim 1, wherein each icon displays at least one of an image, video, or text.

9. The system of claim 1, wherein the software is further adapted to control playback of the full screen video.

10. The system of claim 9, wherein the software is further adapted to display information related to the full screen video during control of playback.

11. The system of claim 1, wherein the software is adapted to receive and store a selection of a favorite, a selection of a video to add to a watchlist, an indication that the user likes the currently displaying full screen video or selected icon, or a an indication that the user dislikes the currently displaying full screen video or selected icon.

12. The system of claim 1, wherein the full screen video is one of a live TV show, a streaming TV show, a live movie, a streaming movie, information from the Internet, and an IPTV video.

13. The system of claim 1, wherein the software displays options of viewing content from multiple sources simultaneously.

14. The system of claim 13, wherein the software displays options of viewing content from multiple sources without indicating the source.

15. The system of claim 13, wherein the multiple sources are chosen from the list comprising live TV, streaming videos, the Internet, IPTV, cable systems, satellite systems, and DVR.

16. The system of claim 1, wherein the software is further adapted to display an icon indicating that the full screen video contains an interactive feature.

17. The system of claim 16, wherein the software is further adapted to display the interactive feature and accept interaction from the user upon the user selecting to view the interactive feature.

18. The system of claim 1, wherein the user is able to navigate through different submenus without returning to the main menu.

19. The system of claim 1, wherein the user is able to search for content and information using key words.

20. The system of claim 1, wherein there are a plurality of users and each user is able to customize the user interface.

21. A method for displaying a user interface (UI) as an overlay on a full screen video on a display device, the method comprising the steps of, on a computing device coupled to the display device:
displaying a main menu, the main menu comprising a first plurality of icons in a strip, one icon displaying a reference to a current user and at least one other icon displaying a reference to a category;
receiving a selection of one of the first plurality of icons;
displaying a first submenu associated with the selected icon, the first submenu comprising a second plurality of icons in a strip;
wherein the first submenu replaces the main menu upon the selection of the icon;
receiving a selection of one of the second plurality of icons; and
at least one of displaying a second submenu and changing the full screen video based on the selection of one of the second plurality of icons.

22. The method of claim 21, wherein there are a plurality of other icons in the main menu, each displaying a reference to a different category.

23. The method of claim 21, wherein the category is at least one of live TV, movie library, show library, sports, celebrities, favorites, and extras.

24. The method of claim 21, wherein each icon of the main menu is associated with a different first submenu.

25. The method of claim 21, wherein there are additional submenus associated with each selection, each submenu comprising a plurality of icons in a strip and each icon displaying a different option for that submenu.

26. The method of claim 25, wherein at least one additional submenu provides information about a selected icon.

27. The method of claim 26, wherein the information is related to at least one of a selected show, a selected movie, and a selected celebrity.

28. The method of claim 21, wherein each icon displays at least one of an image, video, or text.

29. The method of claim 21, further comprising controlling playback of the full screen video.

30. The method of claim 29, further comprising displaying information related to the full screen video during control of playback.

31. The method of claim 29, further comprising receiving and storing a selection of a favorite, a selection of a video to add to a watchlist, an indication that the user likes the currently displaying full screen video or selected icon, or a an indication that the user dislikes the currently displaying full screen video or selected icon.

32. The method of claim 21, wherein the full screen video is one of a live TV show, a streaming TV show, a live movie, a streaming movie, information from the Internet, and an IPTV video.

33. The method of claim 21, further comprising displaying options of viewing content from multiple sources simultaneously.

34. The method of claim 33, further comprising displaying options of viewing content from multiple sources without indicating the source.

35. The method of claim 33, wherein the multiple sources are chosen from the list comprising live TV, streaming videos, the Internet, IPTV, cable systems, satellite systems, and DVR.

36. The method of claim 21, further comprising displaying an icon indicating that the full screen video contains an interactive feature.

37. The method of claim 36, further comprising displaying the interactive feature and accepting interaction from the user upon the user selecting to view the interactive feature.

38. The method of claim 21, wherein the user is able to navigate through different submenus without returning to the main menu.

39. The method of claim 21, wherein the user is able to search for content and information using key words.

40. The method of claim 21, wherein there are a plurality of users and each user is able to customize the user interface.
